(19) United States
(12) Patent Application Publication
(10) Pub. No.: US 2026/0148211 A1
(43) Pub. Date: May 28, 2026

(54) SYSTEM AND METHOD OF PROVIDING OFF-CHAIN ATTRIBUTION FOR TOKEN TRANSACTIONS

(71) Applicant: Castor Pollux Holdings, S.a.r.l., Luxembourg (LU)

(72) Inventors: Shaun WACKERLY, London, KY (US); Andrey LEE, Redmond, WA (US); Henryk SARAT, Jersey City, NJ (US)

(21) Appl. No.: 18/961,993

(22) Filed: Nov. 27, 2024

(51) Int. Cl. G06Q 20/12; G06Q 20/06

(52) U.S. Cl. CPC G06Q 20/123; G06Q 20/0658; G06Q 2220/10

(57) ABSTRACT

Systems and methods are disclosed for generating attribution data associated with transactions. An apparatus can include at least one memory and at least one processor coupled to the at least one memory and configured to: receive an event associated with a transaction in a network; determine, based on the event, a proposed change to a group attribution state by reading first data from a first table that stores a listing of group addresses in which each member in the listing of group addresses has at least one respective member address and second data from a second table comprising the group attribution state; and apply the proposed change to the group attribution state to the second table to obtain an updated second table with a new attribution state.

### TECHNICAL FIELD

The present disclosure generally relates to tokens generated and traded in blockchain networks and more specifically to an off-chain service that provides attribution benefits to originators, groups, or other entities, as well as providing attribution data for groups or other entities such as bad actors in the process of mining and trading or selling tokenized assets on a computer network such as one or more blockchain networks.

### BACKGROUND

This disclosure relates to blockchain networks and the tokens that are generated or originated and then traded between participants of a blockchain network. In some cases, attribution benefits can be provided for participants who mint, originate or participate in trading tokens on the blockchain network. Some attribution algorithms implement on-chain attribution with tokens like USDV (Verified US Dollar) and addresses the problem of tracking the origin (or “color”) of fungible tokens as they are transferred between users. The algorithm allows for the precise attribution of tokens to their original issuer (originator) while ensuring that tokens retain their fungibility. USDV typically refers to a collateralized stablecoin produced by LayerZero that is pegged to the U.S. dollar. The use of USDV is often part of decentralized finance (DeFi) ecosystems and aims to maintain a stable value relative to the dollar, backed by various forms of collateral such as other cryptocurrencies or assets. The “V” in USDV can stand for a particular protocol or platform that issues or manages the stablecoin. For example, one protocol issues USDV, where users can mint USDV by supplying assets as collateral. The token can be used for trading, lending, or yield farming across DeFi platforms. Different protocols may have variations of USDV depending on their specific implementation or collateral model.

In the context of USDV, one algorithm enables precise attribution of the token back to its issuer even after it has been transferred multiple times. This is useful for a variety of applications, including yield-sharing models and collateral-based stablecoins. However, such an algorithm remains on-chain and is thus incumbered by such issues as the cost in gas to manage the transactions in a way that provides attribution.

Next, the blockchain performs tracking of ownership and attribution. When assets are transferred on a blockchain network, the coloring or metadata is preserved along with the transaction record. This allows the origin of an asset or token to be traced back through the blockchain ledger. By checking the color or metadata associated with the token, anyone on the network can verify the ownership history, creator, and provenance of the asset. This attribution ensures that even as assets change hands, their origin and important details remain traceable and immutable.

The process uses smart contracts configured on the blockchain. Smart contracts, which are self-executing agreements coded into the blockchain, can be used to enforce rules around asset attribution. For example, a smart contract could stipulate that the original creator of a token or asset must always receive a percentage of future sales or transfers. This ensures continuous attribution to the original owner, even in decentralized markets. These rules can be automatically executed based on the asset's metadata or color, creating a transparent and fair system for tracking ownership and usage rights.

The data is recorded on an immutable ledger for verification. Blockchain's inherent immutability means that once an asset is colored and attributed, it cannot be altered or erased. This ensures that the provenance, ownership, and attribution data are secure and permanent. Any changes to the ownership or state of the asset are appended to the blockchain, creating a verifiable history that can be accessed at any time.

The approach can enable integration with public and private blockchains. Some of these algorithms can be implemented on both public and private blockchain networks. On public blockchains, it provides a decentralized method for asset attribution. On private or consortium blockchains, it can be customized for specific industries or enterprise use cases, offering a more controlled environment for tracking assets and maintaining attribution within a closed group. In summary, some attribution algorithms work by attaching metadata (colors) to blockchain tokens or assets, enabling seamless tracking of ownership, provenance, and attribution. These algorithms leverage the blockchain's immutability and transparency to ensure that assets can be traced back to their origins, and smart contracts can automate attribution rights. However, it also is encumbered by the cost of performing transactions on the blockchain and thus can be expensive to use.

### SUMMARY

A crypto coin issuer may wish to attribute the amount of tokens in circulation to the originators/distributors who have contributed to those tokens' use. The attributed circulation may be used to calculate rewards, measure the effectiveness of particular marketing activities, or identify bad actors, among others (i.e., this is not an exhaustive list of applications for the disclosed attribution system). Other participants may not be entities who originate (i.e., mint), or may be distributors and can include entities such as influencers who have not originated tokens nor traded them may also desire benefits for token transitions as well. The disclosure introduces a system for using an off-chain approach toward attribution. The attribution system 102 can propose movements according to transfer methodologies and apply attribution rules. The disclosed attribution system 102 includes support for lossless cross-chain attribution, includes detection and prevention of abuse cases and supports rollback for experimentation and bug fixes.

The disclosed system improves upon prior approach by providing minimized fees (gas) for on-chain transfers, the ability to be portable to different token types and chains. The system may be retrofitted to an existing token and can enable retroactive calculations/bug fixes/rollback, with no limitations on accuracy or cross-chain transfers and support for multiple attribution methodologies. The disclosed approach in its broadest sense is not limited to an off-chain system meaning that the transactions that are being tracked have to be part of a blockchain network. In many cases, the innovations are independent of the blockchain network and can be applicable to any network. In other cases, the concepts can apply to a tokenized asset which may or may not be a blockchain token but can include any digital asset. Further, the principles can apply to tracking transactions associated with any entity including bad actors that would not get a “benefit” but may have some action taken based on attribution data generated by the system.

In some aspects, the techniques described herein relate to an apparatus for generating attribution data associated with transactions, the apparatus including: at least one memory; and at least one processor coupled to the at least one memory and configured to: receive an event associated with a transaction in a network; determine, based on the event, a proposed change to a group attribution state by reading first data from a first table that stores a listing of group addresses in which each member in the listing of group addresses has at least one respective member address and second data from a second table including the group attribution state; and apply the proposed change to the group attribution state to the second table to obtain an updated second table with a new attribution state. Group addresses can be listings of one or more addresses that are associated with an entity. The entity might include a group, a contributor, or bad actor, or any entity associated with transactions related to the event, such as a transfer of a tokenized asset. The “entity” can also include characteristics (such as addresses which are located in a geographic region or created during a particular time window), where those characteristics are not an entity.

In some aspects, the techniques described herein relate to a method for generating attribution data associated with transactions, the method including: receiving an event associated with a transaction in a network; determining, based on the event, a proposed change to a group attribution state by reading first data from a first table that stores a listing of group addresses in which each member in the listing of group addresses has at least one respective member address and second data from a second table including the group attribution state; and applying the proposed change to the group attribution state to the second table to obtain an updated second table with a new attribution state.

In some aspects, the techniques described herein relate to a computer-readable storage medium storing instructions, which, when executed by a processor, cause the processor to be configured to: receive an event associated with a transaction in a network; determine, based on the event, a proposed change to a group attribution state by reading first data from a first table that stores a listing of group addresses in which each member in the listing of group addresses has at least one respective member address and second data from a second table including the group attribution state; and apply the proposed change to the group attribution state to the second table to obtain an updated second table with a new attribution state.

In some aspects, the techniques described herein relate to an apparatus for generating attribution data associated with transactions. The apparatus includes at least one memory; and at least one processor coupled to the at least one memory and configured to: receive an event associated with a transaction in a network; determine, based on the event, a proposed change to a group attribution state by obtaining first data related to a listing of group addresses in which each member in the listing of group addresses has at least one respective member address and second data from a table comprising the group attribution state; and apply the proposed change to the group attribution state to the table to obtain an updated second table with a new attribution state. The first data can be passed in a request. In some aspects, the event can flag whether an address is tracked and stored in an address table.

In some aspects, the techniques described herein relate to a method for generating attribution data associated with transactions, the method can include receiving an event associated with a transaction in a network; determining, based on the event, a proposed change to a group attribution state by obtaining first data related to a listing of group addresses in which each member in the listing of group addresses has at least one respective member address and second data from a table comprising the group attribution state; and applying the proposed change to the group attribution state to the table to obtain an updated second table with a new attribution state.

In some aspects, the techniques described herein relate to a computer-readable storage medium storing instructions, which, when executed by a processor, cause the processor to be configured to: receive an event associated with a transaction in a network; determine, based on the event, a proposed change to a group attribution state by obtaining first data related to a listing of group addresses in which each member in the listing of group addresses has at least one respective member address and second data from a table comprising the group attribution state; and apply the proposed change to the group attribution state to the table to obtain an updated second table with a new attribution state.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and aspects, will become more apparent upon referring to the following specification, claims, and accompanying drawings.

### BRIEF DESCRIPTION OF THE DRAWINGS

Illustrative aspects of the present application are described in detail below with reference to the following figures:

FIG. 1A is a diagram illustrating an attribution system providing attributions to a transaction network, in accordance with some aspects of this disclosure;

FIG. 1B is a diagram illustrating an attribution system providing attributions to a transaction network in which the network is a blockchain network, in accordance with some aspects of this disclosure;

FIG. 2 is a diagram illustrating a component diagram of an attribution service, in accordance with some aspects of this disclosure;

FIG. 3 is a diagram illustrating another component diagram providing a crypto-coin attribution service, in accordance with some aspects of this disclosure;

FIG. 4 illustrates another component diagram providing a crypto-coin attribution service, in accordance with some aspects of this disclosure;

FIG. 5 illustrates a block diagram including a public blockchain and a crypto-coin attribution service, in accordance with some aspects of this disclosure; and

FIG. 6 is a block diagram including a cross-chain event and a crypto-coin attribution service, in accordance with some aspects of this disclosure;

FIG. 7 is a diagram that illustrates an attribution gateway, in accordance with some aspects of this disclosure;

FIG. 8 illustrates a public blockchain and a crypto-coin attribution service, in accordance with some aspects of this disclosure;

FIG. 9 is a block diagram illustrating a crypto-coin attribution service, a message queue and a rewards service, in accordance with some aspects of this disclosure;

FIG. 10 is a block diagram illustrating in more detail the rewards service, in accordance with some aspects of this disclosure;

FIG. 11 is a block diagram illustrating in more detail the rewards service, in accordance with some aspects of this disclosure;

FIG. 12 is a flow diagram illustrating transfer event queuing, in accordance with some aspects of this disclosure;

FIG. 13 is a flow diagram illustrating transfer attribution, in accordance with some aspects of this disclosure;

FIG. 14 is a flow diagram illustrating a report generation workflow, in accordance with some aspects of this disclosure;

FIG. 15A is a flow diagram illustrating various re-attribution approaches, in accordance with some aspects of this disclosure;

FIG. 15B is an example method of generating attribution data, in accordance with some aspects of this disclosure;

FIG. 15C is another example method of generating attribution data, in accordance with some aspects of this disclosure;

FIG. 16 illustrates an example method of generating attribution data, in accordance with some aspects of this disclosure;

FIG. 17 illustrates a method embodiment, in accordance with some aspects of this disclosure; and

FIG. 18 is a diagram illustrating an example system architecture for implementing certain aspects described herein, in accordance with some aspects of this disclosure.

### DETAILED DESCRIPTION

Certain aspects of this disclosure are provided below. Some of these aspects may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the example aspects will provide those skilled in the art with an enabling description for implementing an example aspect. It should be understood that various changes may be made in the function and arrangement of elements without departing from the scope of the application as set forth in the appended claims.

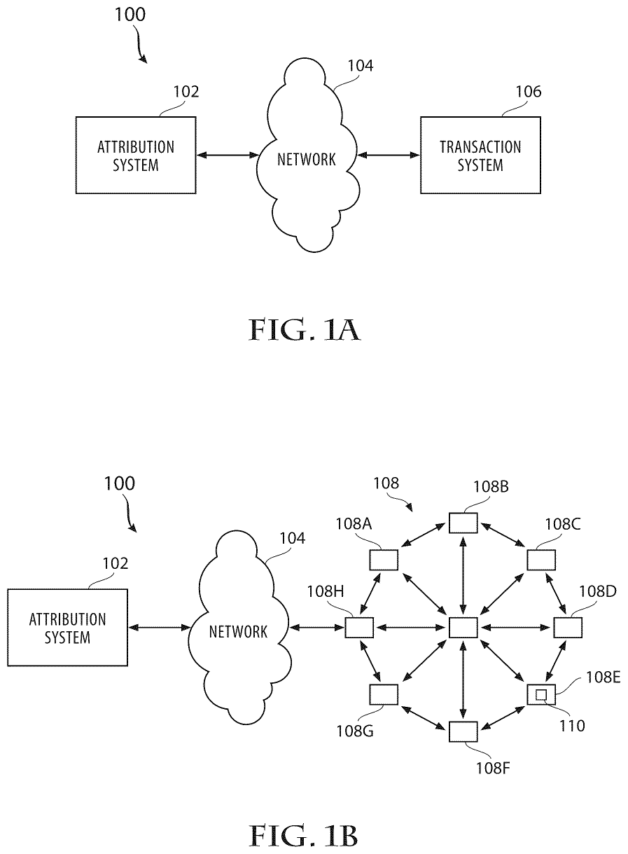

FIG. 1A is a diagram illustrating an attribution system providing attributions to a transaction network, in accordance with some aspects of this disclosure. A system 100 can include an attribution system 102, a network 104 such as the Internet or any other network, and a transaction system 106. The approach disclosed herein can relate to any transaction system 106 which can include a computer network performing operations or may include a blockchain network 108 as is shown in FIG. 1B. Attribution can refer to the identification of how many crypto-coins, tokens or (more broadly) tokenized assets are originally minted for (or attributed to or originated with) a particular group are still in circulation at a particular time. A group tag can be used to provide an attribution reference to a particular group. That is, if a tokenized asset has a given tag, then that tokenized asset is attributed to the group with that tag value. Each group has a unique tag. When the disclosure references “circulation”, this term can refer to the total number of tokenized assets in existence for any given tag. For example, one may consider the circulation as the number of tokenized assets minted or originated for a respective group. Circulation may refer to the number of tokens which have been minted/originated but have not yet been burned/terminated. An “attributed circulation” can refer to a portion of the circulated tokenized assets which are attributed to a particular group. A reward based on the attribution can be monetary payment based upon the attributed circulation, holdings, and/or transfer volume which a group has generated during a period of time. The reward may be other benefits as well besides a monetary payment and can include other benefits such as originated tokens, etc.

Note that an entity can mint tokens which are then transferred to a partner or group who is their “originator”. Thus, entities may mint tokens or may be deemed the “originator” who originates tokens for use. The term “origination” can refer to either minting of a token or receiving the token from a wallet which is not considered to be “in circulation”. Further, as used herein, the term “terminate” can refer to tokenized assets that are transferred to a particular recipient who will take them out of circulation and may or may not burn the tokenized assets.

The attribution system 102 can include a number of components that might be referred to in other figures and can encompass one or more components including the attribution-service or a tokenized-asset attribution system, a messaging queue, and various databases. The references to the attribution system 102 is meant be a general reference to one or more example implementations discussed below.

FIG. 1B is a diagram illustrating an attribution system providing attributions to a transaction network in which the network is a blockchain network 108, in accordance with some aspects of this disclosure. The blockchain network 108 can include blockchain nodes 108A, 108B, 108C, 108D, 108E, 108F, 108G, 108H, 108I can each include instances of software components such as a consensus algorithm and a distributed ledger. In this manner, transactions that occur or that need to be recorded on the blockchain network 108 may only be recorded on a distributed ledger when a threshold level of consensus is obtained from a distributed consensus algorithm on the blockchain network 108. In this manner, data is recorded on the distributed ledger in a manner that is immutable meaning that the only way to change the data would be to gain consensus from the distributed consensus algorithm. The manner in which data is stored on the blockchain network 108 differs from regular data stored in a computer memory that can be erased or changed without the protections built into the structure of the blockchain network 108. Transactions in the transaction system 106 might include a transfer of a digital object or tokenized asset such as a token form a source address to a destination address. Participants in the transfer can include an entity that originated a token or the digital object, a participant to helped advertise or process a transfer, or other parties who might directly or indirectly participate in the ecosystem that enable the transaction system 106 to function. In some cases the participant might be a bad actor and the attribution system 102 can be used to attribute or record transactions that identify the bad actor and take an appropriate action.

As discussed herein, many examples will relate to the blockchain network 108 and cryptocurrency or token originating operations and transfers. However, the principles disclosed herein are broader in context and in many cases do not require a blockchain network 108 or the particular features associated with the blockchain network 108. Thus, unless expressly stated, the principles can apply to any computer network and any transactions, tokenized assets or events that occur in a transaction system 106 or computer network.

In some aspects, where transactions in the transaction system 106 relate to crypto currencies or tokens, a crypto coin or tokenized asset issuer may wish to attribute the amount of tokens in circulation to the originators/distributors who have contributed to those tokens' use. The attributed circulation may be used to calculate rewards, measure the effectiveness of particular marketing activities, or identify bad actors. Other types of transactions independent of cryptocurrency tokens may also have similar objectives of seeking to reward or incentivize participants in a transaction ecosystem. This disclosure describes a system for using an approach toward attribution. The attribution can be for transactions in general that occur in a transaction system 106 or may be specific to a blockchain network 108. Proposed herein is to track movements according to transfer methodologies and apply attribution rules when events occur in the transaction system 106.

In some aspects, the attribution system 102 can be implemented via a smart contract 110 configured on the blockchain network 108. In other aspects, and in most of the examples provided herein, the attribution system 102 is separate from or remote from the transaction system 106 or the blockchain network 108 and thus operates “off chain”, meaning that it simply receives data regarding events or transactions that have occurred on the transaction system 106 and operates as disclosed herein to determine the proper attribution for the groups that participate in making the ecosystem work. The disclosed attribution system 102 includes support for lossless cross-chain attribution, includes detection and prevention of abuse cases and supports rollback for experimentation and bug fixes. An address group can be all addresses which are owned by a particular corporate entity, e.g. such as a currency exchange that invests effort to grow usage of a token, with the benefit of reaping rewards from a token yield.

In another aspect, “on-chain” attribution may also be disclosed in which the attribution system 102 is embedded in a smart contract 110 or a program configured on the blockchain network 108. However, in some aspects, a particular attribution system 102 may not accomplish lossless cross-chain transfers if it were deployed on-chain.

This disclosure solves the problem of how to attribute circulating tokens to the entity or entities which originated, distributed, promoted, or otherwise participated in the token ecosystem on the blockchain network 108. The information can be used to identify rewards (such as yield from an underlying asset) or to otherwise attribute the entity or entities who were involved with getting those tokens to the current holder. One disclosed innovation, that applies when the attribution system 102 is configured off-chain, improves upon the prior solutions in many ways including minimizing fees for on-chain transfers, the attribution system 102 is portable to different token types and chains, the attribution system 102 may be retrofitted to an existing token, the attribution system 102 allows for retroactive calculations/bug fixes/and rollback, there are no limitations on accuracy or cross-chain transfers and there can be support for multiple attribution methodologies. Again, some of these benefits specifically apply to the use of the blockchain network 108 while other benefits can apply to any kind of transaction system 106.

Disclosed are multiple options for how to implement a group attribution for cryptocurrencies or tokens, each having their own benefits and tradeoffs. The token can be a stablecoin which distributes yield to groups involved in the originating, holding, and transacting of that coin. Any cryptocurrency or other evidence of any type of transaction is contemplated as within the scope of this disclosure. One decision is the choice over whether the attribution system 102 computes group attribution on-chain or off-chain.

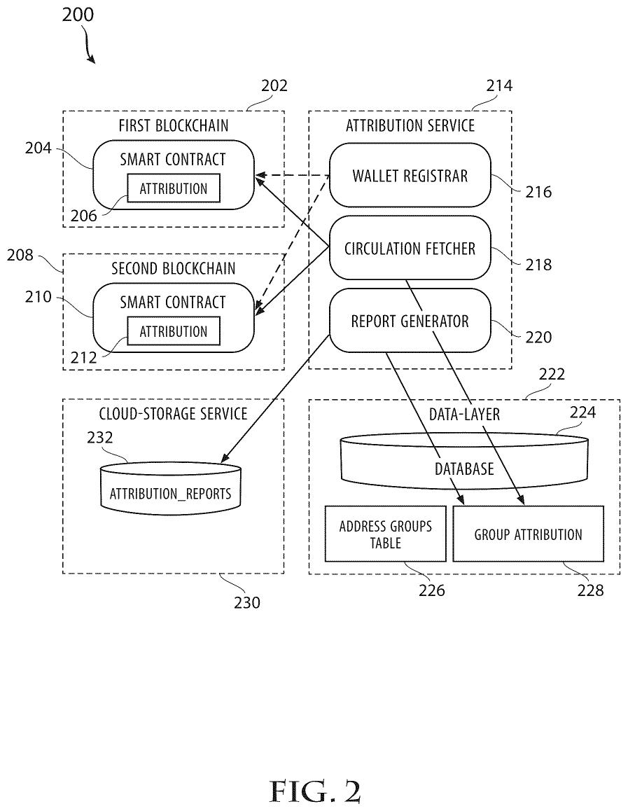

FIG. 2 is a diagram illustrating a component diagram of on-chain attribution 200 of an attribution-service, in accordance with some aspects of this disclosure. The component diagram of on-chain attribution 200 illustrates an first blockchain 202 having a second blockchain smart contract such as the smart contract 110 (which can represent any on-chain smart contract on any blockchain network) and a first attribution component 206. A second blockchain 208 is shown with program plus data or second blockchain smart contract 210 and a second attribution component 212. The second blockchain smart contract 210 can represent any program, data or smart contract on a blockchain network.

The token can be a consortium coin, which will deliver rewards to groups who promote the distribution and utility of the coin. These rewards are given based upon attributed circulation, holdings, transaction volume, and referral activity. The token may be released on the first blockchain 202 and the second blockchain 208, with cross-chain transfer support. To calculate the active circulation which can be attributed to a particular group, a attribution service 214 can use a form of token tagging from the point when a token is originated for a particular group, until that token is burned or otherwise terminated. This description refers to these tags as group IDs.

The on-chain system referenced in FIG. 2 can embed the attribution calculation within the smart contract/program on the blockchain network 108. The smart contract 110 is inherently involved in every transfer. A first attribution component 208 is on the first blockchain 202 and a second attribution component 212 is configured on the second blockchain 208. When a transfer occurs, the smart contract 110 updates supplementary attribution data on a per-wallet basis. The supplementary calculation will add gas fees to the transfer, since it adds computation and data storage. The benefit to a service provider such as the attribution service 214 is that there is no operational cost for the computation or storage of attribution data for each transfer on a service provider platform.

The attribution service 214 includes a wallet registrar 216, a circulation fetcher 218, and a report generator 220. The report generator 220 can generate or update attribution reports 232

Group addressesA group addresses table 226 can be pre-configured in the smart contract 110 itself so that the group addresses addresses table 226 can be used to attribute tokens which flow through them. The group addresses addresses table 226 can be wallet addresses which force attribution to the respective group. The configuration could be done by the attribution service 214 for groups who send the attribution service 214 their wallet addresses or done directly by groups themselves. The circulation fetcher 218 of the attribution service 214 fetches attribution snapshots from each chain periodically (e.g., daily, hourly, or on some other schedule), then stores them in a data layer 222 using a database 224 as a group attributions table 228. The group attributions table 228 represent a per-group summary of the total circulation attributed to that group at a given point in time. There may be, for example, three-hundred and sixty-five entries in a year. The group attributions table 228 can also be called the group attributions table. The circulation snapshot table 228 can also be referred to herein in some case as a “second table” that is used by the attribution system 102.

In many instances as used herein, a “first table” is the group addresses table 226. This table can also include or be characterized as a listing or table of group addresses. For example, an address group might be listing of one or more addresses for a group in connection with originating, transferring, or otherwise participating in the use of a tokenized asset. The address group may also be a set of 1+ addresses which might create a group of known bad actor addresses. The attribution system 102 can track the circulation attributed to those bad actors. These actors would not be a group but an entity that is part of a defined group.

The reference to any “table” as used herein can refer to any kind of data storage, such as a blob, binary data, and so forth.

The group attributions table 228 can be queried at the end of the month by the report generator 220 to compute an average attributed circulation for that month (i.e., originated coins which have not been terminated). The average attributed circulation report is stored in a cloud storage service 230 and used to compute rewards for each group.

The benefit of the approach of FIG. 2 is minimal operational cost for the attribution service 214, transparency in how attribution is done (for groups) and it becomes possible to offload address group configuration. There may be some negative aspects to the configuration as well. There may be added gas fees per transfer (i.e., an in-chain transfer) plus larger gas fees per cross-chain transfer since there is more information due to the cross-chain transaction. There will be an additional implementation for each blockchain and thus higher development effort. The approach is not readily portable to other token types and other chains. Any bugs in attribution would require a blockchain update and there may be a need for smart contract audits to confirm transactions which can be expensive. When the number of groups increases beyond a threshold such as thirty groups, a synchronization layer may be needed which adds operational cost, complexity, and development effort.

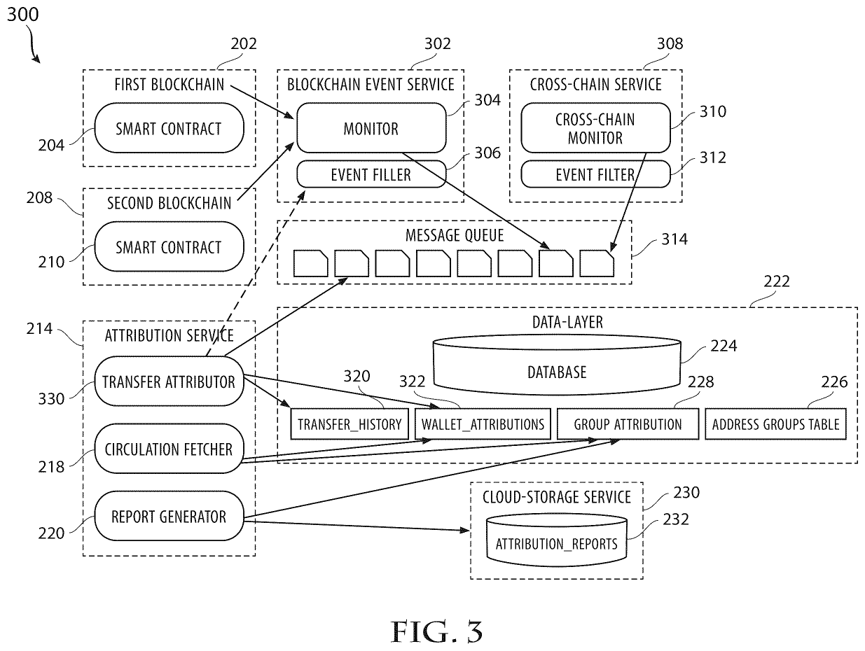

FIG. 3 is a diagram illustrating another component diagram of off-chain attribution 300 providing a crypto-coin attribution service or more broadly a tokenized asset attribution service or a blockchain event service 302, in accordance with some aspects of this disclosure. In some aspects, the system of FIG. 3 would not embed any attribution operations into the smart contract/program on the blockchain. The attribution calculation is performed off-chain. To perform off-chain attribution, an off-chain rewards service such as attribution service 214 receives a copy of transfer events from a blockchain event service 302.

The blockchain event service 302 can receive all in-chain transfer events as part of blockchain processing. These events can be handled within the blockchain event service 302 by a blockchain monitor 304. To make events visible outside the blockchain event service 302 (i.e., to the off-chain attribution service such as attribution service 214) the blockchain event service 302 uses a supply-side event filter 306 to add events to a message queue 314 which the attribution service 214 reads from. The attribution service 214 already uses a cloud storage service 230 as a message queue 314 to send/receive events. The supply-side event filter 306 restricts the volume of transfer events which get queued. The supply-side event filter 306 is configured either statically or dynamically.

In some aspects, tokenized assets can generally refer to assets originated, traded and recorded on the blockchain network 108. These tokenized assets can be of different types. For example, cryptocurrencies such as Bitcoin or first blockchain can be tokenized assets as that term is used herein. Non-fungible tokens or NFTs represents another example of a tokenized asset. In a broader sense as well, a tokenized asset may represent a digital record of an assert (physical or virtual) on a computer network or transaction system 106 that may not be configured as the blockchain network 108. The blockchain event service 302 may read events related to any kind of tokenized asset.

The attribution service 214 does not receive cross-chain transfer events and they may be slower to adopt new chains than what a cross chain service 308 could allow. A new monitor associated with a cross-chain service 308 outside of the attribution service 214 adds cross-chain transfer events to the message queue 314. A cross-chain monitor 310 uses a cross-chain event filter 312 to add the cross-chain transfer events to the message queue 314. Without cross-chain monitoring supported internally, cross-chain transfers would be treated as a termination, which attributes the tokens to a service provider. The token may also be terminated otherwise. A termination of a token can include a termination but may also include putting a token into a wallet which is then used a source when an entity “originates” more tokens later on.

Internal to the attribution service 214 is a transfer attributor 330 that is responsible for processing transfer events from the message queue 314. Key data from each transfer event is optionally stored in a transfer history database 320 in a data layer 222 having a database 224. Optionally, a transfer history database 320 can include all transfers which occurred on-chain. This approach may be needed for replay to resolve bugs or compare algorithms. The transfer attributor 330 calculates how the transfer affects attribution and stores the result in a per-wallet attribution database 322 which relates to a per-wallet attribution state which represents the total amount within a user wallet which is attributed to a given group (i.e., {customer 123: {red: 10, blue: 30, green: 25, timestamp}}). The data stored in this table is not a transfer history database 320. Each entry is the latest state of the attribution for a particular wallet address. Writing new data overwrites the prior data for that wallet address.

The per-wallet attribution data is the off-chain equivalent for on-chain attribution data in the smart contract 110 discussed with reference to FIG. 2. However, while per-wallet attribution data is the off-chain equivalent, the format may differ. There is no need to compress data to save space in on-chain storage; therefore, the format can be different. A circulation fetcher 218 fetches a snapshot of the per-wallet attribution data and stores a summary of the attribution as a circulation snapshot in a snapshot database or circulation snapshot table 228. A report generator 220 is called periodically (i.e., monthly, weekly, daily, or at a random or variable time frame) to calculate the average circulation for that period, and store that report in the cloud storage service 230 in an attribution reports database 232. The group addresses table 226 is also shown in FIG. 3 as well.

The off-chain approach of FIG. 3 has some benefits where it makes attribution applicable to any token type or any EVM and non-EVM blockchain. There are no extra gas fees for users and avoids legal risks with distribution algorithms. Bugs and optimizations can be implemented and remediated much more quickly. The approach does include operational costs for the attribution service 214 to calculate attribution and optionally requires additional monitoring for cross-chain transfers.

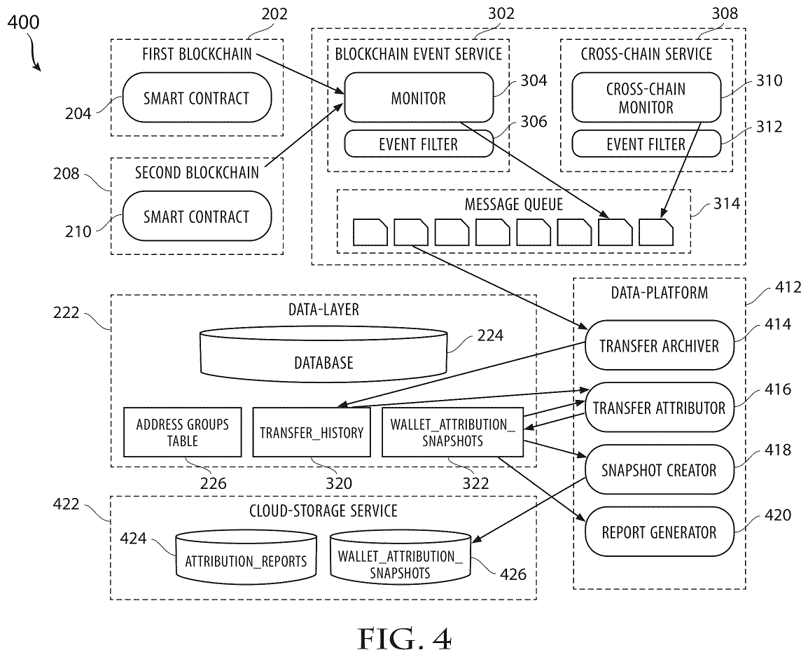

FIG. 4 illustrates another component diagram for off-chain batch attribution 400 and a blockchain event service 302, in accordance with some aspects of this disclosure. The system of FIG. 4 refactors the approach in FIG. 3 to fit within the batch processing framework of the data platform. The system receives token transfers from a Source of Truth (e.g., the blockchain event service 302 through the message queue 314), then batch-processes transfers to compute the latest state of group attribution data. To avoid duplicate work, it stores verified wallet attribution snapshots. To minimize storage, it deletes old transaction history.

In FIG. 4, the “source of truth” comes from either the blockchain event service 302 or the cross-chain service 308. A data-platform 412 can include one or more operations or jobs which can be implemented by, for example, a transfer archiver 414, a transfer attributor 416, a snapshot creator 418 and a report generator 420. In some aspects, an example job can include a transfer archiving job operated by the transfer archiver 414 for taking data in one step from the source of truth and accumulate the data in a transfer history table 320 which can, in some aspects, be partitioned by date. The data-layer 222 can include a database 224 with group addressesa group addresses table 226, the transfer history table 320 and a wallet attribution snapshot record such as a circulation snapshot table 322. The transfer archiver 414 can help perform this operation in another step.

A transfer attributor job can be implemented by the transfer attributor 416 to provide a daily trigger to move data from a select range from the transfer history table 320 to join a wallet attribution snapshot table previous date in the wallet attribution snapshots database 322. The job can be triggered daily or in any other time frame. It selects unprocessed transactions from the transfer history table in the transfer history database 320 and joins them with the previous attribution snapshot. The joined data is pushed through the transfer attributor 416 which can be programmed, for example, in computer programming languages like golang or python, which applies the unprocessed transactions to the prior snapshot to produce a new snapshot. Pseudo code for the transfer attributor job can include by way of example: {Job_Trigger}-> [Select data range from TransferHistoryTable Join WalletAttributionSnapshotTablePreviousDate]-> [TransferAttributor Operator]-> [WalletAttributionSnapshotTableToDate].

A snapshot creator job can be implemented by the snapshot creator 418 in example pseudo code as follows: {On [WalletAttributionSnapshotTableToDate] available-trigger}-> [SnapshotCreator Operator]->output an attribution report. When the latest wallet attribution snapshot is computed, the snapshot creator 418 outputs the data to the cloud storage service 422 which optionally can be accessed by groups for transparency, if desired. A wallet attribution snapshots database 426 can store this data.

A report generator job can be implemented, for example, by the report generator 420 in pseudo code as follows: {Monthly-trigger}-> [Select Daily snapshots for a month]-> [ReportGenerator Operator]->output to a database. Once a month or on any other timeline, the daily snapshots are pushed through, the report generator 420 which creates a summary with average per-group attributed circulation. The summary is output to the cloud storage service 422, to be accessed by a finance entity to compute rewards for each group. Benefits of the approach of FIG. 4 include that one can rely on a proven batch processing framework instead of building a bespoke solution and makes the data available for other purposes in the future. Other benefits are similar to those of FIG. 3.

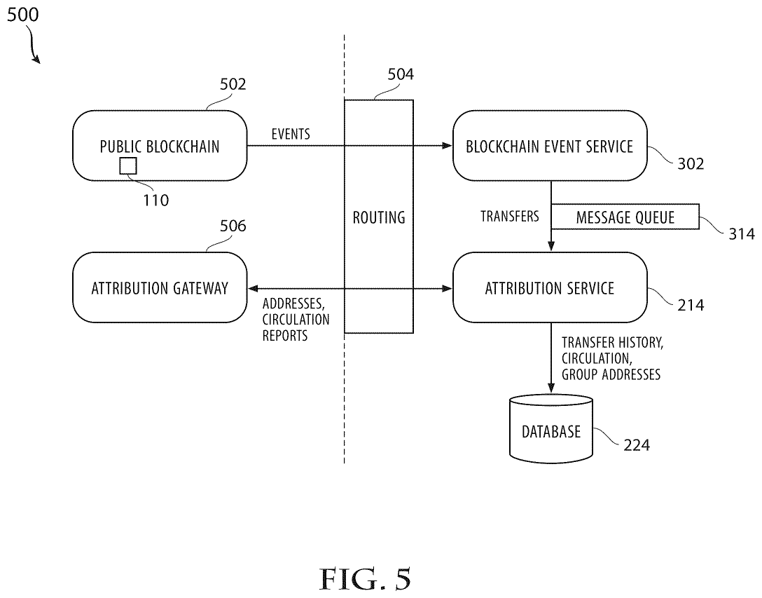

FIG. 5 illustrates a block diagram representing an off-chain group token attribution system 500 including a public blockchain 502 and a blockchain event service 302, in accordance with some aspects of this disclosure. To incentivize groups for promoting token creation, an off-chain group token attribution system 500 can attribute coin existence to a particular group. For instance, suppose that a group like a cryptocurrency exchange initiates an origination of 1M tokens when the current circulation is 99M tokens (originated for other groups). The approach is to reward the cryptocurrency exchange as long as this 1M has not been redeemed (i.e., terminated), as an incentive for the cryptocurrency exchange to drive further adoption and use. Suppose a single customer wants to redeem 2M tokens of the total 100M circulation. The way in which a user can know that the 2M includes the 1M which was originated by a cryptocurrency exchange is through tracking events and making the proper determination or attribution as disclosed herein.

One example goal of this disclosure includes equitably attributing the portion of total circulation to the group which distributed that amount of circulation on-chain. Another goal can be to generate attribution for other entities such as bad actors to take appropriate actions. The primary embodiment is an off-platform attribution but as noted above, another embodiment applies to on-platform attribution. For example, one can implement on-platform attribution by adding the transfer messages by adding an algorithm to the smart contract 110 or generically to on-chain transaction processing. The attribution computation may be done live on-chain, or retroactively off-chain. The approach disclosed herein supports retagging. When a token originated by one group flows through the wallet of another group, that amount (or some portion) should be attributed to the group who owns that wallet. Further, as has been introduced above, the disclosed approach supports multiple chains (e.g., first blockchain 202, second blockchain 208) and can handle cross-chain transactions.

Tags can be used as an abstract attribution mechanism. Attribution can be performed on-chain within the smart contract 110, or off-chain by replaying transfers from the blockchain history. A public blockchain 502 contains a smart contract 110 which facilitates token transfers. The smart contract 110 does not have (for the off-chain approach) any embedded code which tracks attribution. The smart contract 110 emits events (like transfers) which are observed by nodes (see FIG. 1B) as the blockchain network 108 verifies each new block. The blockchain event service 302 receives the events by using each blockchain's remote procedure call (RPC) interface or RPC interface 504 (i.e., for routing) to query for events or receive events in new blocks that are recorded on a ledger of the public blockchain 502. As has been explained above, the message queue 314 receives data about the transfers and uses the off-chain rewards service such as attribution service 214 to record in a database 224 (i.e., using the various tables disclosed herein) transfer history, circulation and group addresses). An attribution gateway 506 can be used via the RPC interface 504 to exchange data with the attribution service 214.

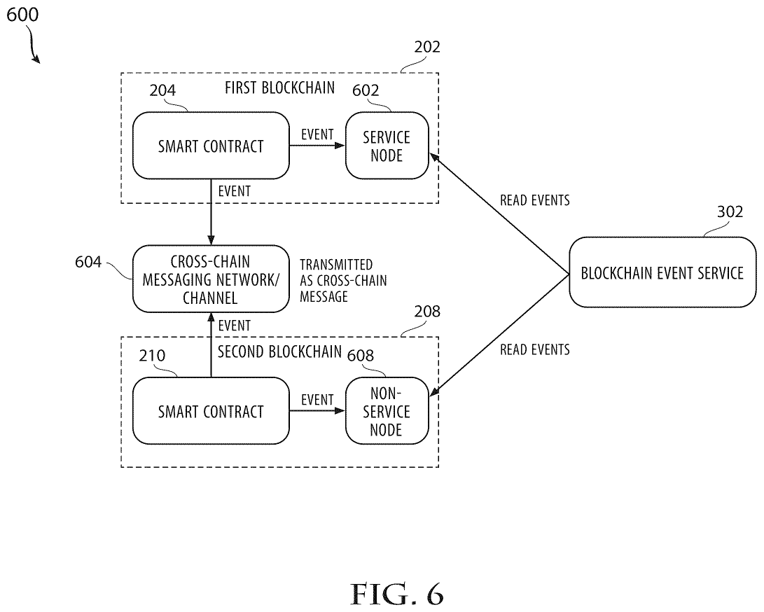

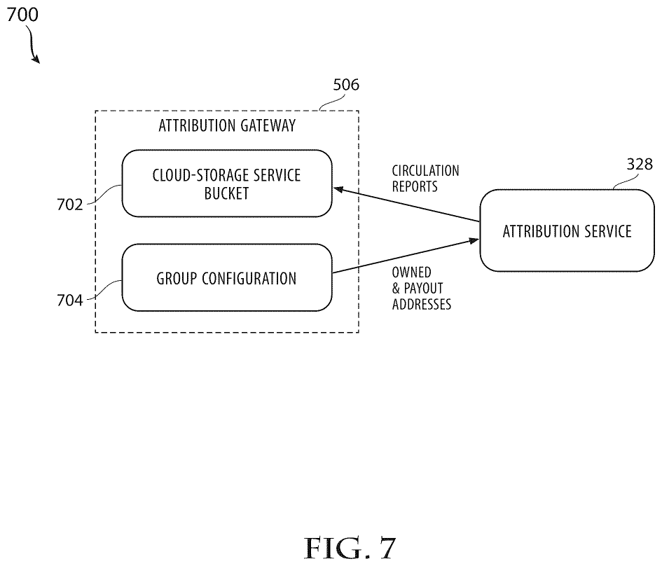

FIG. 6 is a block diagram of a cross-chain framework 600 and blockchain event service 302, in accordance with some aspects of this disclosure. In this regard, when a token is transferred from the first blockchain 202 to another blockchain such as the second blockchain 208, the blockchain event service 302 can track or read the events that occur across the different blockchain networks and assign the appropriate attribution to groups.

The event is transmitted via the cross-chain messaging network/channel 604 as a cross-chain message. The second blockchain 208 can include a second blockchain smart contract 210 that also provides events to a second service node 608. The first service node 602 and the second service node 608 can both communicate events by transmitting event data to the blockchain event service 302.

The first service node 602 and the second service node 608 can be operated by the same company or entity or different entities. A first entity can run the first service node 602 as a verifier node in the first blockchain 202. Having a node running in each blockchain network is not a requirement to have visibility into blockchain events.

In some aspects, for the tokens, the first service node 602 would listen for events (PacketSent and/or PacketReceived) which indicate a cross-chain transfer.

In a specific example, the first blockchain smart contract 204 and the second blockchain smart contract 210 exist on-chain and are involved in every transfer which transfers a token. These smart contracts can be standard ERC-20 compliant smart contracts for the first blockchain and for the second blockchain, or any other blockchain network. The first blockchain smart contract 204 and the second blockchain smart contract 210 will not have any embedded knowledge that attribution calculations are taking place for each transfer. The main function of the smart contracts (relative to attribution) is to provide transfer events.

FIG. 7 is a diagram that illustrates an attribution gateway framework 700, in accordance with some aspects of this disclosure. The attribution gateway 506 can include a storage bucket 702 and a group configuration 704. The attribution service 214 provides circulation reports to the storage bucket 702 and receives owned and payout addresses from the group configuration 704. The attribution gateway 506 is a mechanism by which groups provide and obtain information relative to attribution. Specifically, groups will provide circulation data and configure group-owned addresses.

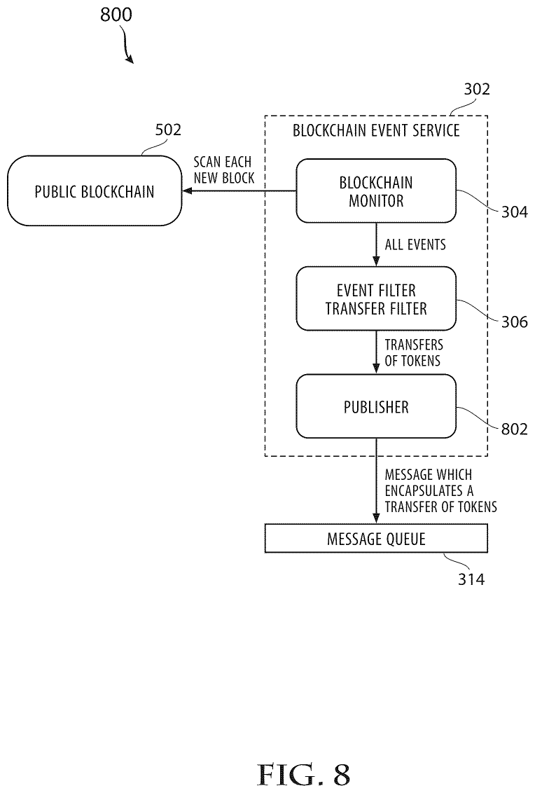

FIG. 8 illustrates a public blockchain and a crypto-coin attribution service framework 800, in accordance with some aspects of this disclosure. The public blockchain 502 operates to enable the blockchain event service 302 to scan each new block recorded on the distributed ledger for event data. The blockchain monitor 304 receives events when it scans every new block on each blockchain network. The events are passed through the transfer filter 306 which is configured to filter out any event which is not a transfer of the token. The blockchain monitor 304 provides the events to the transfer filter 306 which identifies transfers of a token and passes the filtered events to a publisher 802. The transfers which are allowed by the transfer filter 306 will be given to the publisher 802 which will publish the transfer events to the message queue 314. The publisher 802 can generate a message which encapsulates a transfer of the token and provide the message to the message queue 314.

The blockchain event service 302 in some aspects can be a cross-chain abstraction layer which provides all transfer events which occur on the public blockchain. The transfer filter 306 can be updated if other listeners will receive other transfer types.

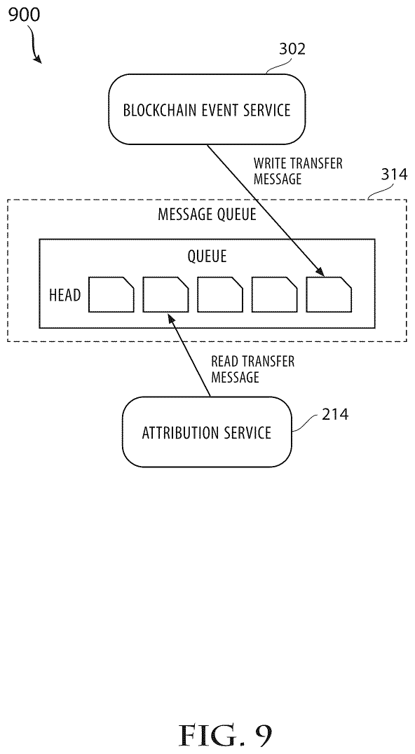

FIG. 9 is a block diagram illustrating a crypto-coin attribution service, a message queue and a rewards service framework 900, in accordance with some aspects of this disclosure. The blockchain event service 302 writes a transfer message to the message queue 314 and the attribution service 428 reads a transfer message from the message queue 314. There are a number of different options for a message bus implementation. RabbitMQ is an example queue that can be used by the blockchain event service 302 to send messages from the blockchain monitor 304 to the transfer filter 306.

SQS is another example of a queue that can be used by the attribution service 214 to send and receive messages internally. In another aspect, Kafka can be used as it is in other services, such as Know Your Customer applications, banking applications, etc. Those of skill in the art will understand these various tools for processing messages.

In some aspects, Kafka can be the message queue implementation for attribution for the following reasons: (1) The queue should preserve message order and scalability can be important; (2) The queue should support replays in which it is used to replay messages (in the event that a bug is encountered and the attribution system 102 needs to recalculate attribution). The queue should include basic characteristics such as it being durable and ordered.

The attribution service 214 computes the total circulation and makes the data available for groups. It receives information about transfers and group-owned addresses, then orchestrates the computation of attributed circulation from this data. The attributed circulation is published for group consumption. The attribution system 102 can receive and process all transfers involving a token, not just transfers for group-owned addresses.

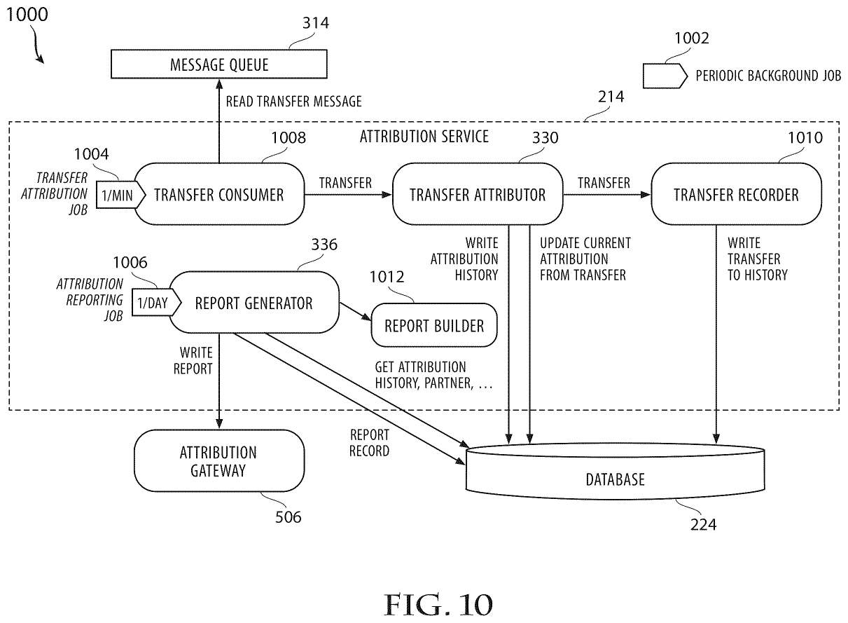

FIG. 10 is a block diagram illustrating in more detail an example overview attribution service 1000, in accordance with some aspects of this disclosure. The attribution service 214 reads transfer messages from the message queue 314. A transfer consumer 1008 consumes messages from the message queue 314 and sends them via a transfer attributor 330 to a transfer recorder 1010. The attribution service 214 can be implemented as a constantly running task which repeatedly checks new messages for example once per minute via a transfer attribution job 1004 or on some other timeframe. Both originate/terminate messages/events, as well as other possible events will also be consumed by the attribution service 214 from the message queue 314. An attribute reporting job 1006 can run, for example, once per day in association with the report generator 336 to generate reports at the desired time frame. The attribute reporting job 1006 can run periodically or be event-driven or triggered by some event.

The transfer attributor 330 updates the group attributions database table in the database 224 based on the contents of the transfer. The transfer attributor 330 will identify the portion of attributed circulation at the source address, then transfer that attributed circulation to the destination address. The results of the transfer will be updated in the group attribution database table, as well as any attribution changes into an attribution history table.

The transfer recorder 1010 records each transfer into persisted storage in the transfer events. A report generator 336 generates reports for groups and a service entity based on the contents of the group attributions, other entity (i.e., bad actor, or other entity) attributions, transfer events, and attribution history tables. Reports are published to the attribution gateway 506. The groups may receive these reports as well after they exist in the database 224. The approach could also include combining forces with a ledger reporting service, or from a customer perspective provide the same access through a user interface, secure file transfer protocol (SFTP), email for the groups or with a unified reporting experience.

A report builder 1012 builds report content (e.g., in a CSV or comma-separated values format) based on provided input. The report builder 1012 can be an internal helper for the report generator 336, which gathers the provided input.

The database 224 stores information which needs to be persistent because it will either be difficult, costly, or impossible to recalculate. The database 224 stores group-provided information (addresses), the transfer and attribution history, group attributions per-address, and attribution reports. In some aspects, this disclosure uses two tables which store data related to group addresses and attribution states. These two tables, the group address table an attribution state table can be stored in the database 224 as well as other data.

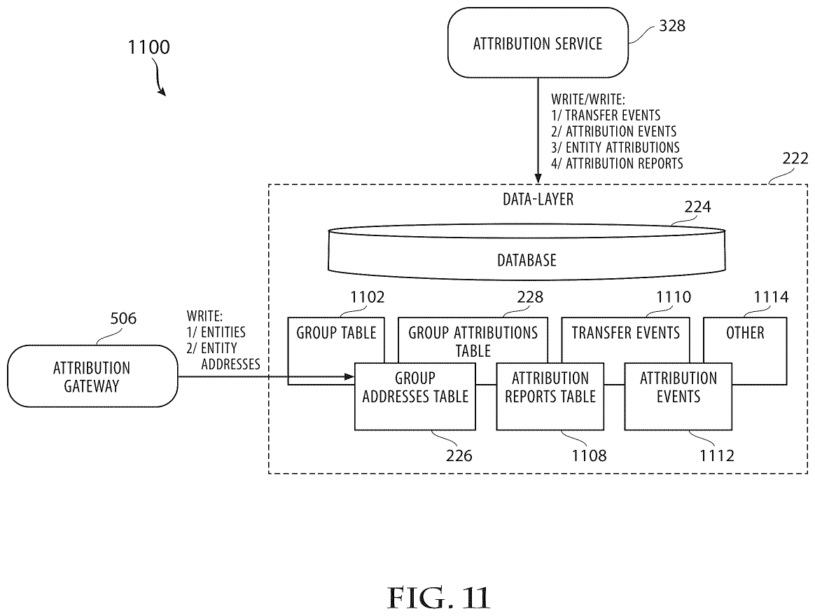

FIG. 11 is a block diagram illustrating in more detail the data layer 222 and a database framework 1100, in accordance with some aspects of this disclosure. The attribution service 214 reads and writes transfer events to a transfer events table 1110, attribution events to an attribution events table 1112, group attributes to a group attributions table 228, and attribution reports to an attribution reports table 1108 and from the database 224. The other table 1114 can represent any other kind of data that might be stored in the dataset 224. The attribution gateway 506 will write group data to a group table 1102 and group addresses to a group addresses table 226. These tables may also include data for other entities besides groups such as one or more addresses for a bad actor or other entity participating in the originating and distribution of tokenized assets. The “group” references could be equally applicable to any entity such as a bad actor, other entity or group based on characteristics that supports or is directly or indirectly participating in the distribution of tokenized assets.

The group attributions table 228 holds information about groups who are involved in the distribution and usage of a token. The groups will potentially receive rewards from attributed circulation. The group attributions table 228 can include fields like payout addresses and can map a globally unique ID to the group name. As noted elsewhere, in each place where group attributes is discussed, these attributes can refer to any entity that has attributes tracked, including bad actors or any other entity associated with the originating and use of tokenized assets. Table 1 illustrate an example schema of the group attributions table 228.

TABLE 1

| Field | Type | Description | Example |
|---|---|---|---|
| Id | uuid | Unique ID for this group | E828B5FE-0318- |
| | | | 4A6E-A2A8- |
| | | | AFA4C6580C06 |
| Name | string | Display name for this group | Group 3 |
| CreatedAt | time.Time | Timestamp when this DB row | 2024 May 10 |
| | | was originally created | 11:22:33.4567 UTC |

The group addresses table 226 holds addresses which are known to be owned by a particular group. These addresses are used during attribution to determine when transferred tokens should be re-attributed to another group, entity or characteristic. Again, the tables can also store “group addresses” which may be generated to store one or more addresses for any kind of entity including a bad actor. The group addresses may be static or persistent or may also be dynamically generated such as when a hacking event or other bad-actor suspicious activity is detected. Then, the attribution service 214 may generate an address group for that bad actor and track events from that point on. Table 2 illustrates an example schema for the group addresses table 226.

TABLE 2

| Column | Type | Description | Example |
|---|---|---|---|
| Address (pk) | string | Address for this wallet | 0x59594c4b3C623CF7 |
| | | | a80ea62c22B00F9d2B |
| | | | 799dEC |
| GroupId (fk) or | uuid | Group to whom transfers | E828B5FE-0318- |
| GroupId | | to this address will | 4A6E-A2A8- |
| | | be attributed | AFA4C6580C06 |
| Blockchain | string | Network (chain) where | Ethereum |
| | | this address resides | |
| CreatedAt | time.Time | Timestamp when this DB | 2024 May 10 |
| | | row was originally created | 11:22:33.4567 UTC |

The group attributions table 228 holds the attributed circulation for each wallet in every blockchain or other type of network transaction. The table fills the role of a distributed cache which is used by the transfer attributor 330 (shown in FIG. 10) in the attribution service 214 to calculate the latest attribution when processing a transfer. The composite key (ck) for the table is a combination of address and group ID. Table 3 illustrates an example schema for the group attributions table 228.

TABLE 3

| Field | Type | Description | Example |
|---|---|---|---|
| Address (ck) | string | Address where this circulation is | 0x59594c4b3C623CF7a8 |
| | | held. The sum of all entries with | 0ea62c22B00F9d2B799d |
| | | a given address represents the | EC |
| | | complete holdings in that | |
| | | address. | |
| GroupId (ck, fk) | uuid | Group to whom this circulation | E828B5FE-0318-4A6E- |
| | | will be attributed | A2A8-AFA4C6580C06 |
| Onchainid | string | The on-chain ID of the transfer | 2E828B5FEE828B5FEE8 |
| | | (tx hash) which last updated this | 28B5FE |
| | | entry. | |
| Blockchain (ck) | network.Network | Network (chain) where this | First blockchain/ |
| | | address resides | Second blockchain |
| LockedAmount | decimal | Locked amount of the asset | 1398745.234 |
| | | which is attributed to the | |
| | | group for this address | |
| UnlockedAmount | decimal | Unlocked amount of the asset | 1234.234 |
| | | which is attributed to the | |
| | | group for this address | |
| AssetType (ck) | enum | Type of asset in circulation | Cryptocurrency Token |
| SnapshotTs | time.Time | A “snapshot” timestamp used | 2024 May 10 |
| | | for rollbacks. Enables roll back | 00:00:00.0000 UTC |
| | | by removing all entries older | |
| | | than that timestamp and then | |
| | | replaying all events from that | |
| | | timestamp moving forward | |
| CreatedAt | time.Time | Timestamp when this DB row | 2024 May 10 |
| | | was originally created | 11:22:33.4567 UTC |
| UpdatedAt | time.Time | Timestamp when this DB row | 2024 May 10 |
| | | was last updated | 11:22:33.4567 UTC |
| TokenAge | decimal | Average age of all tokens at | 3.19 |
| | | this address for this group | |
| TransferCount | decimal | Average number of transactions | 3.14159 |
| | | each token at this address for | |
| | | this group or entity has been | |
| | | involved in up to this point | |

The attribution reports table 1108 includes an entry which is a record for either a group-specific or general report which has been published to the database 224. Other report types are also contemplated within the scope of this disclosure. One might expect one entry per-group (e.g., with a maximum of one hundred) with new entries added daily. Table 4 illustrates an example schema for the attribution reports table 1108.

TABLE 4

| Field | Type | Description | Example |
|---|---|---|---|
| GroupId (fk) | uuid | Group to whom this report | E828B5FE-0318- |
| | | applies. If empty, this | 4A6E-A2A8- |
| | | is a report not specific | AFA4C6580C06 |
| | | to any single group. | |
| Path | string | Attribution gateway | “/Exchange/token/attribution/ |
| | | | 2024/06/13/transactions.csv” |
| ReportType | enum | The type of report | Circulation/Holdings/ |
| | | | Transactions |
| CreatedAt | time.Time | Timestamp when this DB | 2024 May 10 |
| | | row was originally created | 11:22:33.4567 UTC |

The transfer events table 1110 is a record of every transfer which has occurred across all blockchain chains involving a token. For each transfer, the attribution system 102 records the timestamp, source (e.g., a source address or source network), destination (e.g., destination address or destination network), and amount. Where storing the data due to its volume may outweigh its usefulness, the transfer archiving can be skipped. Table 5 illustrates an example schema for the transfer events table 1110.

TABLE 5

| Field | Type | Description | Example |
|---|---|---|---|
| Onchainid | string | ID of the transfer, which is | 0x062edcdc18ff56e |
| | | expected to be the on-chain | dd8e7bf245ceb855e |
| | | tx hash. | e53282d1379aca751 |
| | | | 902e2abce452338 |
| OrderingId | uint64 | A unique value which specifies | 12345 |
| | | the order this event was | |
| | | received, relative to | |
| | | other events. | |
| AssetType | enum | Type of asset transferred. In | Cryptocurrency |
| | | combination with the source | Token |
| | | chain, this can be used to | |
| | | deduce the kafka partition. | |
| Amount | decimal | Amount of tokens transferred | 22575 |
| SourceAddress | string | Source address for the | 0x59594c4b3C623C |
| | | transfer | F7a80ea62c22B00F |
| | | | 9d2B799dEC |
| DestAddress | string | Destination address for | 0x59594c4b3C623C |
| | | the transfer | F7a80ea62c22B00F |
| | | | 9d2B799dEC |
| Blockchain | enum | Network (chain) where this | First blockchain/ |
| | | transfer originated | Second blockchain |
| ConfirmedAt | time.Time | Timestamp when this event | 2024 May 10 |
| | | was confirmed on the | 11:22:33.4567 UTC |
| | | blockchain | |
| CreatedAt | time.Time | Timestamp when this DB row | 2024 May 10 |
| | | was originally created | 11:22:33.4567 UTC |
| State | enum | The state of this transfer | RECEIVED |
| | | event relative to attribution | |

The attribution events table 1112 is a record of changes to attributed circulation for a token, similar to an attribution-specific ledger. For each transfer which is attributed, the attribution system 102 records the transfer Id, group ID, and amount delta. This data will be provided to groups in the attribution report. In the worst case, every transfer would produce two entries in this table (if two groups transfer funds back and forth) resulting in 2.4M entries/year. If the cost of collecting and storing this data outweighs the usefulness, one can prune entries for a group after they have been provided in a published report. Table 6 illustrates an example schema for the attribution events table 1112.

TABLE 6

| Field | Type | Description | Example |
|---|---|---|---|
| OnchainId | string | ID of the transfer which | 5018C8F5-90A8- |
| | | caused this change in | 40C0-A6E7- |
| | | attribution. | E2F739D9F66C |
| GroupId (fk) | uuid | ID of the group whose | 0011-2233-4455 |
| | | attribution changed | |
| | | from this transfer | |
| OrderingId | uint64 | A unique value which | 5714 |
| | | specifies the order this | |
| | | event was received, | |
| | | relative to other events. | |
| AssetType | enum | Type of asset for which | Cryptocurrency |
| | | attribution was modified. | Token |
| Blockchain | enum | Network (chain) where | First blockchain/ |
| | | this change occurred | Second blockchain |
| Delta | decimal | Delta in attribution for | −13.745 |
| | | this group as a result of | |
| | | this event. If Address is | |
| | | specified, this is an | |
| | | address-specific delta. If | |
| | | Address is null, this is a | |
| | | delta in the total | |
| | | attribution. | |
| Total | decimal | New total attribution for | 90.117 |
| | | this group as a result of | |
| | | this event. | |
| ConfirmedAt | time.Time | Timestamp when this | 2024 May 10 |
| | | event was confirmed on | 11:22:33.4567 UTC |
| | | the blockchain | |
| CreatedAt | time.Time | Timestamp when this DB | 2024 May 10 |
| | | row was originally | 11:22:33.4567 UTC |
| | | created | |

The other table 1114 can represent other types of reports such as a table of group-specific reports or a bad-actor list of one or more addresses. A group-specific report can be published on a periodic time frame such as daily and can contain data which enables each group to verify the correctness of their attributed circulation. The report does not include transactions which merely changed attribution within untracked wallets, with no change to the group's total attributed circulation. The report includes the following, in addition to other data, in any kind of format: (1) Total attributed circulation; (2) Total holdings in each group-configured address; (3) Total number of addresses holding a non-zero amount of that group's circulation; and/or (4) List of transactions which affected total attributed circulation. Each transaction includes the timestamp, attribution delta, transaction ID, and resulting total attributed circulation. Access to the report can be restricted to a service entity and the group (using database access controls) so that one group cannot access the data from other groups.

The other table 1114, for example, can be a token data table or a token history table which tracks token data on a per-owned address basis historically. Such a table can be used to accommodate the token data tracking (token age, transfer count).

The other table 1114 may be a table that includes configuration data which the system reads at boot time, but could logically be located in the other table 1114. The configuration is specific to upstream/downstream attribution, and prescribes what multiplier (e.g., range [0,1]) gets applied to a transfer.

A general report can be published periodically such as daily which contains data which enables an internal entity or other entity to calculate the total rewards a group should receive. The report includes (in addition to other data) the following in CSV format or any other format: (1) Total attributed circulation on that day (w/timestamp) for each group; (2) Total holdings in each group-configured address on that day (w/timestamp).

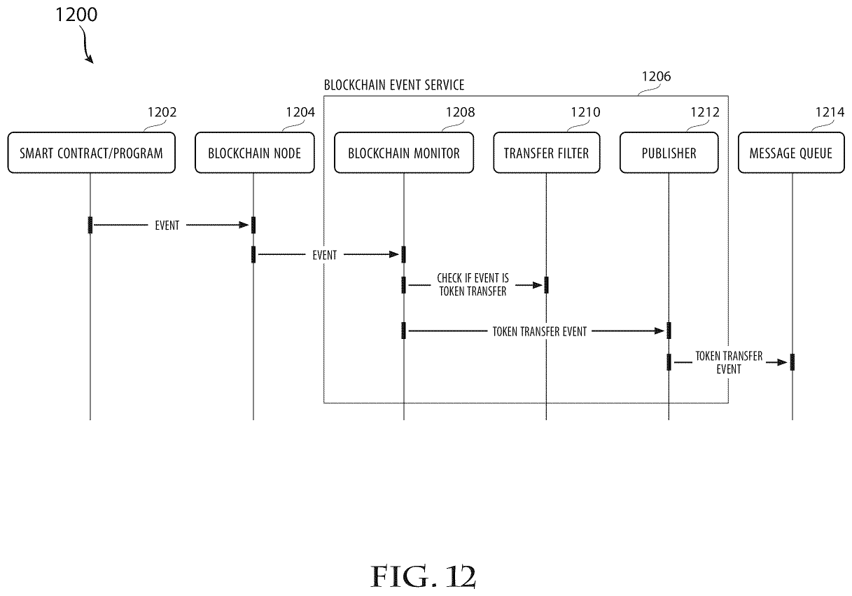

FIG. 12 is a flow diagram illustrating transfer event queuing 1200, in accordance with some aspects of this disclosure. A smart contract 1202 (such as in the first blockchain blockchain) or a program (such as in the second blockchain) emits an event to a blockchain node 1204. The blockchain node 1204 relates to event to blockchain event service 302 which can include a blockchain monitor 304 which passes the event to a transfer filter 1210 to confirm whether it should be published by publisher 1212 to the message queue 314. The transfer filter 1210 in some aspects only allows token transfer events or events related to one or more specific tokens or a specific type of transaction on any kind of network. The blockchain monitor 1208 sends the event (e.g., a token transfer event) to a publisher 1212. The publisher 1212 adds the even to the message queue 1214.

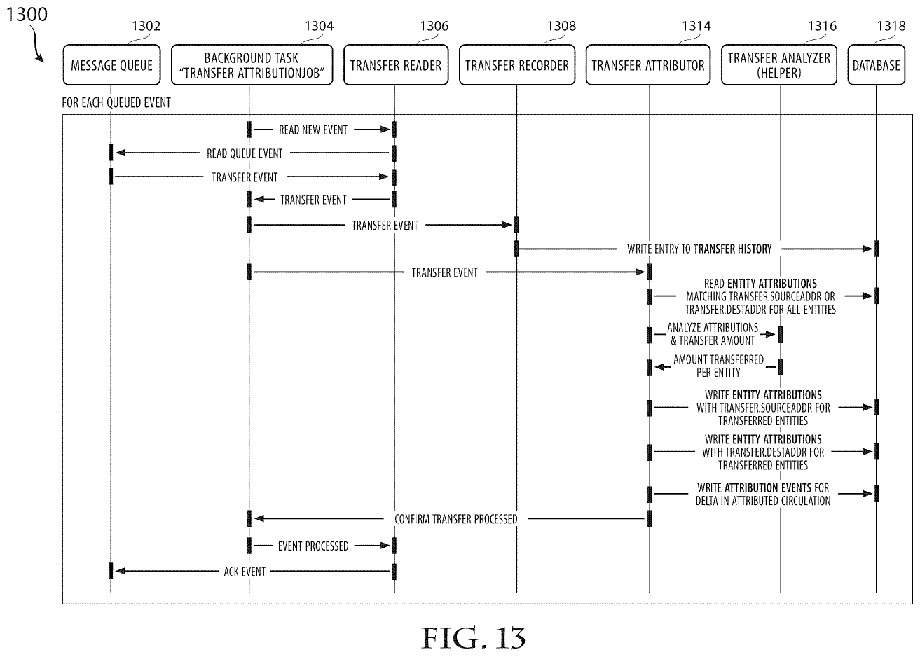

FIG. 13 is a flow diagram illustrating transfer attribution 1300, in accordance with some aspects of this disclosure. A background task 1304 can be implemented that runs periodically such as once a minute or on some other time frame and calls a transfer reader 1306 to check for unprocessed events. The background task 1304 does the following for each unprocessed event: (1) Read the event from the message queue 1402 (via the transfer reader 1406); (2) Call the transfer recorder 1308 to record the transfer event in the database 1418; and (3) Call the transfer attributor 1314 to update group attributions with the results of the transfer. The transfer attributor 1314 uses the transfer analyzer 1316 to identify how the transfer should affect the group attribution. The transfer attributor 1314 records the attribution change in an attribution history table. Next, the flow involves acknowledgement that the event has been processed.

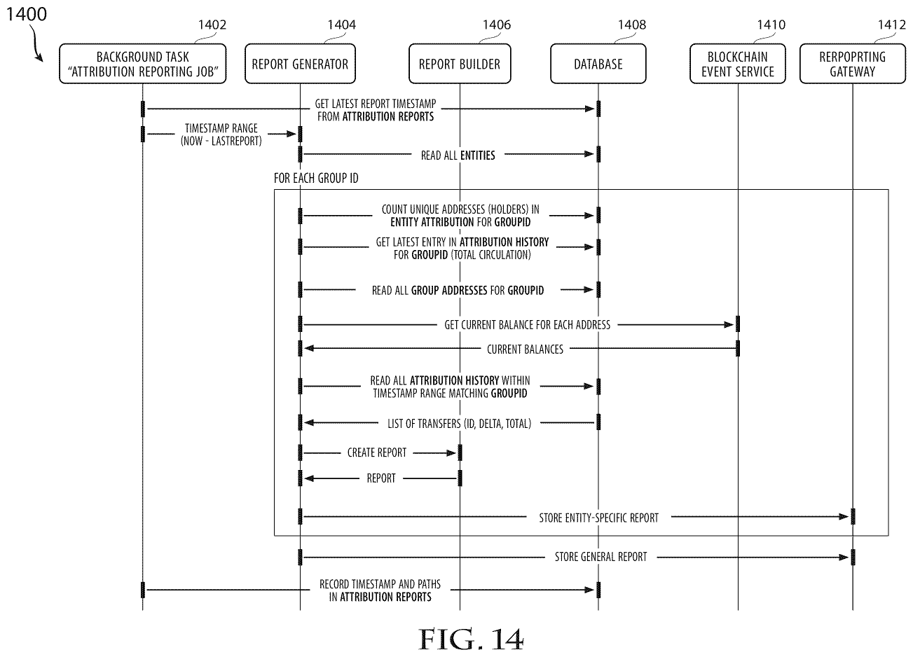

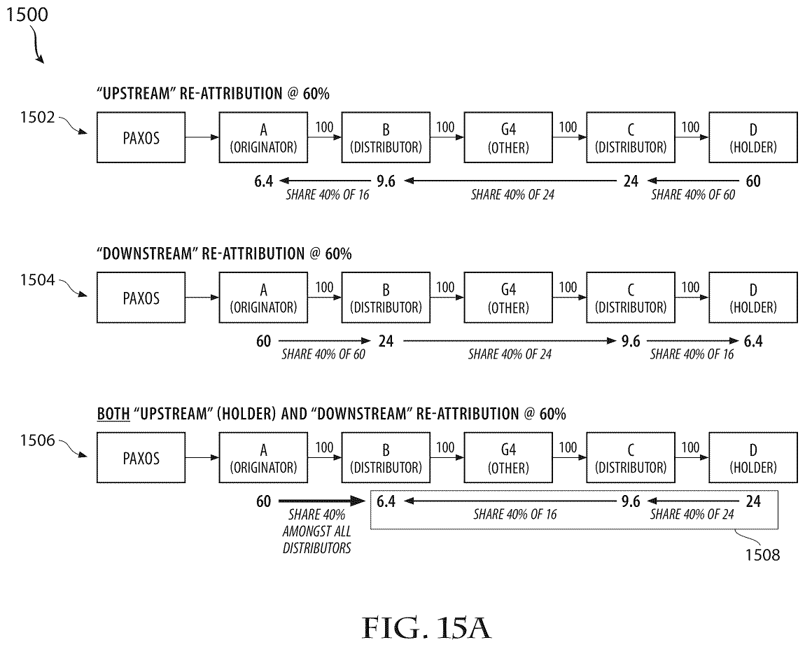

FIG. 14 is a flow diagram illustrating a report generation workflow 1400, in accordance with some aspects of this disclosure. A background task 1402 runs periodically such as once a day or on some other timeframe and calls a report generator 1404 with the timestamp range for the circulation report, based on the timestamp of the latest report. The report generator 1404 reads all entries from the group table 1102. For each group ID in the group table 1102: (1) Count the number of unique addresses in the group attributions table 228; (2) Get the most recent entry for the group ID in an attribution history table.

The workflow next includes get the balance in each group-owned address from the blockchain event service 1410 getting the list of transfers relevant to the group's attribution from attribution history. The flow next combines the above data into a group-specific report in a group report table 108, which is published to a reporting gateway 1412 or any database. The report generator 1404 combines the above data into a general report, which is published to the reporting gateway 1412. The report generator 1404 stores the timestamp and report paths in the attribution reports table 1108.

In the disclosed systems, there may be failure scenarios and detection as well as mitigation techniques to reduce the impact of any failures. For example, there may be a bug in the attribution logic that can be a condition which is detected if the attribution logic observes a per-group balance (globally or within a wallet) which is negative. Specifically, this is detected by the transfer attributor 330 during transfer processing. To mitigate the issue, the attribution system 102 can export and/or replay the transfer events (e.g., from the database 1408) to identify the root cause of the bug. Once the bug is identified, the attribution system 102 can deploy a patched version of the algorithm which will update the attribution history and/or attribution reports affected by the bug.

In one aspect, to maintain high availability, the attribution service 214 can be run with redundancy in place. The data the attribution system 102 accesses can be contained in a database to main high availability.

As noted above, the principles disclosed herein can operate in either an off-chain context or can involve on-chain attribution, which can include an event-driven attribution synchronization. In an on-chain context, a group may detect a notable condition which would substantially increase their circulation, holdings, or transfers. Rather than waiting for a daily job to reach out to the smart contract 110 on a blockchain network 108 to get the latest attribution data, the group may want to send an event to a service entity which prompts the entity to immediately gather an attribution snapshot. The approach gives the group greater attribution accuracy, without requiring the service entity to poll at a higher frequency.

The on-chain context pushes complexity to the group so they need to track large transfers (or cumulatively large sums) to know when to send an event. To simplify this process for the group, one could additionally have the smart contract itself detect when a noticeable difference has occurred since the last time a circulation, holdings, or transfers snapshot occurred. When this threshold was exceeded, the smart contract 110 could reach out to the API to either report its own delta, or to initiate an event which will trigger an attribution snapshot.

An aspect of the event-driven attribution sync is that it costs minimal computing and storage resources for a service entity by fetching data more often. To address this issue, a service entity could measure the delta (or effectiveness) of the event-driven fetch compared to the normal polling frequency. If certain groups are requesting more frequent polling (via too many events) or the times they send events the amounts do not differ from the data polled at the normal polling frequency, the service entity could start to ignore (or penalize) such event senders. This additional processing cost could be analyzed to determine whether the cost outweighs the cost savings it provides.

On-chain reward distribution could also be implemented. Rather than putting the rewards calculation and distribution on-platform (within a service entity), one could create a smart contract 110 which contained a mapping for pseudo-wallets, which aren't actual wallet addresses that receive funds, but instead are used to indicate an action which should be taken. The smart contract 110 would take special action on transfers involving those wallets.

For instance, a reward could be distributed by transferring a yield to wallet address Oxaaaaa . . . aaa. The smart contract 110 would take this to indicate that rewards should be distributed based on holdings volume alone, so it would transfer funds to configured recipient wallets. If a reward was transferred to wallet address Oxbbbbbb . . . bbb then that could indicate rewards based on holdings+circulation+transfers. When any reward wallet received a reward total, it would distribute rewards to the groups who had been involved in the currency since the last reward distribution. This would effectively move much of the attribution system 102 on-chain, leaving only the yield accounting within the service entity. The benefit for groups is that the reward distribution process would be completely transparent, but they will accrue higher gas fees, as described above.

As noted above, this disclosure provides a system to enable a crypto-coin issuer to attribute the amount of tokens in circulation to the originators/distributors or other participants who have contributed to those tokens' use. The attributed circulation may be used to calculate rewards, measure the effectiveness of particular marketing activities, or identify bad actors. The disclosed system improves upon prior approach by providing minimized fees for on-chain transfers, the ability to be portable to different token types and chains, a system that may be retrofitted to an existing token, a system that enables retroactive calculations/bug fixes/rollback, no limitations on accuracy or cross-chain transfers and support for multiple attribution methodologies. The disclosed approach in its broadest sense is not limited to an off-chain system meaning that the transactions that are being tracked have to be part of a blockchain network. In many cases, the innovations are independent of the blockchain network and can be applicable to any network.

In general, the attribution system 102 or system works by listening to events from event sources (1+ blockchains or 1+ non-blockchain computer networks), then processing these events to attribute each portion of the circulating supply to the originator and/or distributor(s) of those tokens. In some aspects, the attribution system 102 listens to only confirmed events (to avoid rollbacks) and processes them sequentially (to avoid the complexity of parallel processing), but these limitations should not apply to the idea as a whole.

As noted above, there are two primary data tables used the implement the attribution system 102 disclosed herein. The data tables could be structured differently in some aspects for performance reasons, but are simplified here for illustration. The group addresses table 226 can store group addresses or a list of groups, entities or characteristics, each of which has 1+ configured monitored addresses. Each group is an entity to which will be attributed a portion of the circulating supply, when that supply moves through one of the associated monitored addresses. Each address is chain-specific or where the network is not a blockchain, may be specific to a network or other entity. A single group may have multiple addresses on the same chain, or the same address across multiple chains, or a combination. Example code for entries in the group addresses table 226 can include: Map<GroupId, List<Address>>.

A group attributions table 228 can contain attributions. This table contains the current “state” of attribution. For each on-chain address which has been the recipient of an origination/termination, the attribution system 102 will record the attributed circulation which is held by that address. In the simplest form, this is a map of each group to the amount attributed to that group (at that address). One can abstract the amount as TokenData to include other types of data which might be tracked. An example code can include: Map<Address, Map<GroupId, TokenData>>.

The disclosure also makes use of some other data tables/caches which are explained herein in context to where they are used.

In some aspects, there may be a series of stages that are performed in the process of attribution for each event. A first stage is reception. The event is received from an event receiver and ordered relative to other events in the order they originally occurred. A second stage is deduplication. The event is checked to see if it has already been processed. If so, it is skipped. A third stage is extraction. State which is relevant to the received event is read from the group attributions table 228 and group addresses table 226. A fourth stage is generating a proposal. The attribution system 102 analyzes the event data (type, source, destination, amount, etc.) and current state to propose a change to the attribution state. A fifth stage is application in which the attribution system 102 applies the proposed change to the group attributions table 228. A sixth stage is recording in which any relevant changes (such as an overall gain/loss of attribution for a given group) are recorded in an audit log. A seventh stage is acknowledgement. The event is acknowledged as having been processed. This information is cached for later reference by the deduplication stage for future events. The details of that stage are explained further below.

A proposal stage determines how circulation is attributed. As discussed above, the group attributions table 228 group attributions table is conceptually a map of groups to the amount attributed to the group at each address involved in circulation. In the implementation, the data is structured as a map keyed by address, where the value is a map keyed by group, where the value is the amount attributed to that group at that address. The output of this proposal stage is a set of proposed changes to the group attributions table 228.

There may be a number of different transfer methodologies. When handling a transfer, the simple case is when all attributed circulation at the address is being transferred to another address. In this case, the entire map value for the old address is emptied and summed into the map value for the new address.

If a portion of the attributed circulation is being transferred from an address, the attribution system can have the choice of how to handle the movement of that partial amount. Potential approaches are described below. Any one or more approach could be applied to a single event.

A first approach is based on historical ordering. Rather than a map of amount-per-group, structure the data as a queue (FIFO) or stack (LIFO) where each element is an amount-per-group transferred into the address in the order it was transferred. In pseudocode this would look like this for a stack: Map<Address,Stack<Map<GroupId, TokenData>>>. When transferring an amount N from the address, the attribution system 102 would remove amounts from the queue/stack until N tokens were consumed. Those moved amounts would retain their original mappings and be transferred to the new address. To move exactly N, the attribution system 102 might need to split the last amount-per-group.

Another approach is proportional to the attributed circulation (in address). When transferring an amount N from an address, the attribution system 102 would proportionally transfer amounts for each group which match the percentage of total address holdings attributed to that group within the address. For example, if an address had 100 tokens (A:10, B:30: C:70) and it transferred 50% of the tokens to another address (i.e., 50 tokens), then the attribution system 102 would move 50% of the amount attributed to each group (A:5, B:15, C:35).

Another approach includes equally splitting attribution across groups. Disregarding how much circulation each group has attributed at the source address, the attribution system 102 can take equal amounts from each group to make up the amount to be transferred. To compute the amount for each group, the attribution system 102 would take the number of groups with non-zero attribution at the source address, then divide the total transferred by the number of groups. If any group had an attributed circulation lower than that portion, the attribution system 102 could reduce the total transfer amount by the amount that group had, zero the group's attributed circulation, and recompute for the remaining groups.

Another approach is based on group characteristics. Some groups may have configured or derived characteristics which would change their priority for transfers. For instance, groups may be configured with a priority level (i.e., pay for priority) and the transfer method is applied first at the lowest priority groups. Examples of derived characteristics are the total amount transferred or originated by the group historically, or the group with the highest or lowest total attributed circulation (globally or within the address).

Another approach is based on destination address. Suppose the attribution system 102 is transferring an amount N of tokens from a source address to a destination address owned by group P. The attribution system 102 could prioritize moving the amounts already attributed to the group P (to reduce total deltas for other groups) or the attribution system 102 could prioritize moving amounts which are not already attributed to the group P to increase reattribution based on transfers.

Another approach is to use a randomly-selected group. In this approach, a group ID is randomly selected from the address and the group's attributed amount is either exhausted or the entire transfer is subtracted from it and repeated until the transferred amount is met.

Another approach is based on discrepancies. To reduce data storage costs, debugging complexity, and other benefits of reduced entropy, the proposal could target reducing discrepancies between the source and destination addresses. The attribution system 102 would propose a transfer of attribution for groups who had the greatest differences (i.e., in terms of total amount or percentage at the address) between the source and destination addresses.

Some of the above approaches may be used in combination, but the attribution system 102 likely would never use all combinations together due to complexity, but could in some instances use most or all of the approaches. In some aspects, the attribution system 102 might first apply prioritization based on the group characteristics, then for all groups at the lowest priority level the attribution system 102 would transfer proportionally to their attributed circulation within the source address.

Rounding errors might be an issue when implementing the principles disclosed herein. Some methodologies described above use floating-point arithmetic to compute the proposed amounts for each group (such as the proportional to attributed circulation approach). There may be some instances where the sum of every proposal does not exactly match the total amount transferred/burned/terminated. In that case, the attribution system 102 can calculate a “delta” using transfer.total—sum (proposals). The attribution system 102 adds the delta to one or more of the proposals to make up the difference. The attribution system 102 selects which group(s) proposals will be adjusted by using the group with the largest proposal. The downside of this aspect is that it sometimes or always penalizes the top holder of attributed circulation in that address. Other potential approaches include: (1) adjusting the smallest group proposal (to reduce entropy); (2) adjusting a random group proposal (to promote fairness); and (3) proportionally distributing the delta (applying the same algorithm to the delta which we applied to transfer.total).

The stage of applying the proposal can include the attribution system 102 writing data to the group attributions table 228. Specifically, it applies the proposed changes to the source address and destination address. When proposing a move of N tokens from address A to address B, where the attributed group for those tokens changes from X to Y, the attribution system 102 would perform the following updates: (1) read group attributions for address A, group X. Cache this value as V1; (2) read group attributions for address B, group Y. Cache this value as V2; (3) write V1-N in group attributions for address A, group X; and (4) write V2+N in group attributions for address B, group Y.

Some aspects of this disclosure include applying attribution rules and reattribution rules. In some cases, it may be beneficial to avoid moving all attributed circulation when a transfer occurs. For instance, a group who is a “middle man” (always passing tokens from an originator to a redistributor) would have very little motivation in terms of attributed circulation to operate in that capacity. However, if some of the attributed circulation was shared with this type of group, they would have motivation to operate as a “middle man”. Generally, some type of attributed circulation sharing will motivate groups to cooperate.

To achieve this behavior, the disclosure provides a system that configures rules(s) which determine how much of the attributed circulation is shared. These rules(s) specify a modifier, a matcher, an exclusivity, and a method. The method can vary and can be for example a modifier which determines how much of the attributed circulation is shared with other groups when a matched transaction occurs. In some aspects, this approach is simply a percentage of the attributed circulation involved in the transaction.

A method matcher approach determines whether the percentage is applied to any given transaction. Fundamentally this would match against transaction type (mint/burn/transfer/crosschain/originate/terminate), but may also match against other characteristics like source/destination address, transfer amount, time of day, etc. In our implementation, this just matches an address in group addresses. In other applications, we may want to attribute a percentage of all attribution during a particular time window to a given promoter or influencer.

An exclusivity approach relates to using a value which specifies whether other matched rules should be applied with this matcher. The approach may specify that the rule is entirely exclusive (i.e., applied only if it is the only match), may specify that the rule excludes all rules which have not yet matched (at a lower priority), or may specify that this rule is not exclusive.

Another method determines the method by which attribution is shared with other groups. One example implementation specifies two methods: (1) an upstream method in which the configured modifier (percentage) is shared with the upstream group(s) who brought the attributed circulation to this group; and (2) a downstream method in which the configured modifier (percentage) is shared with the downstream group(s) who take up the circulation after it leaves this group. The rule matching and application could be performed using an ordered list, where each rule is analyzed (and applied) in sequence until the attribution system 102 matches an exclusive rule, or until the attribution system reaches the end of the list.

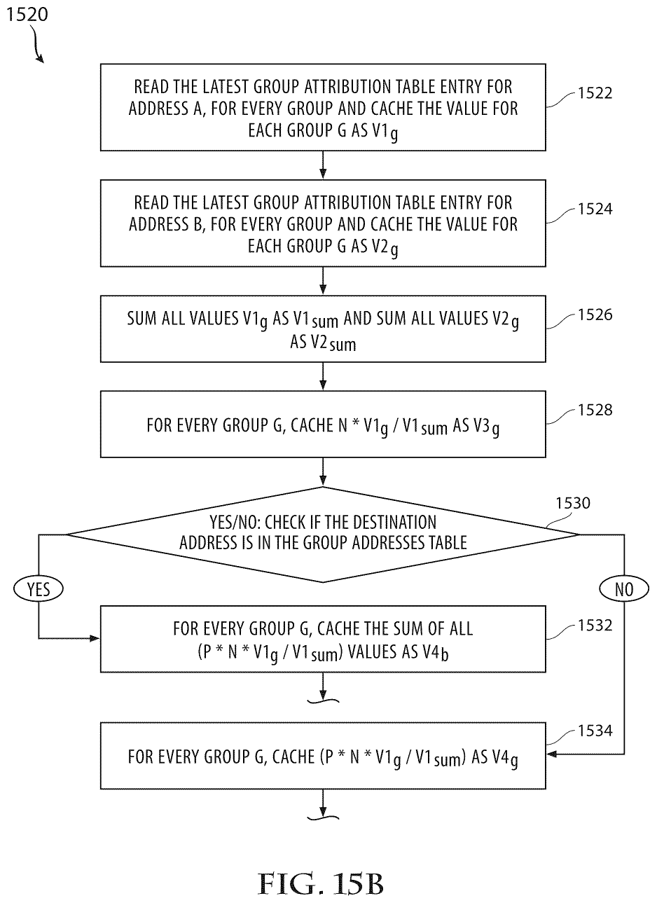

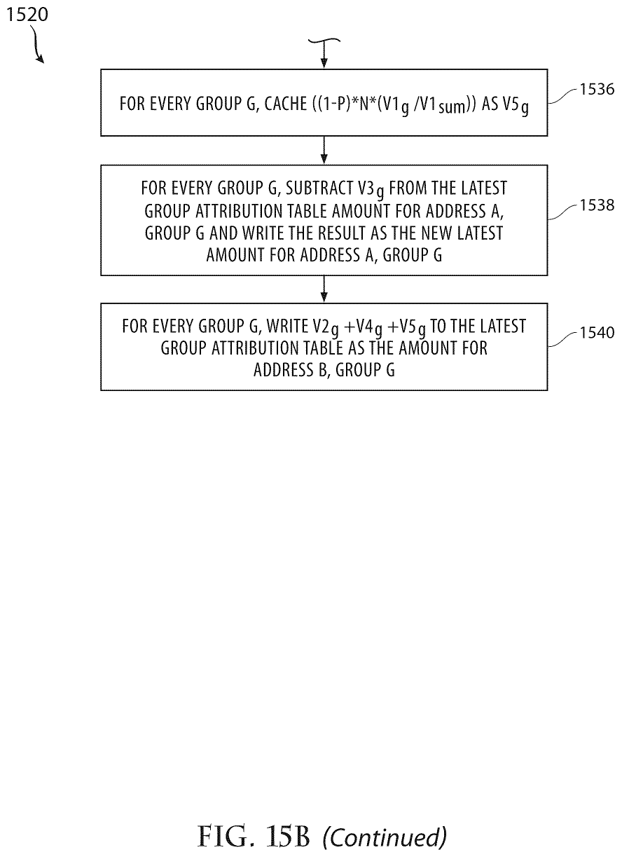

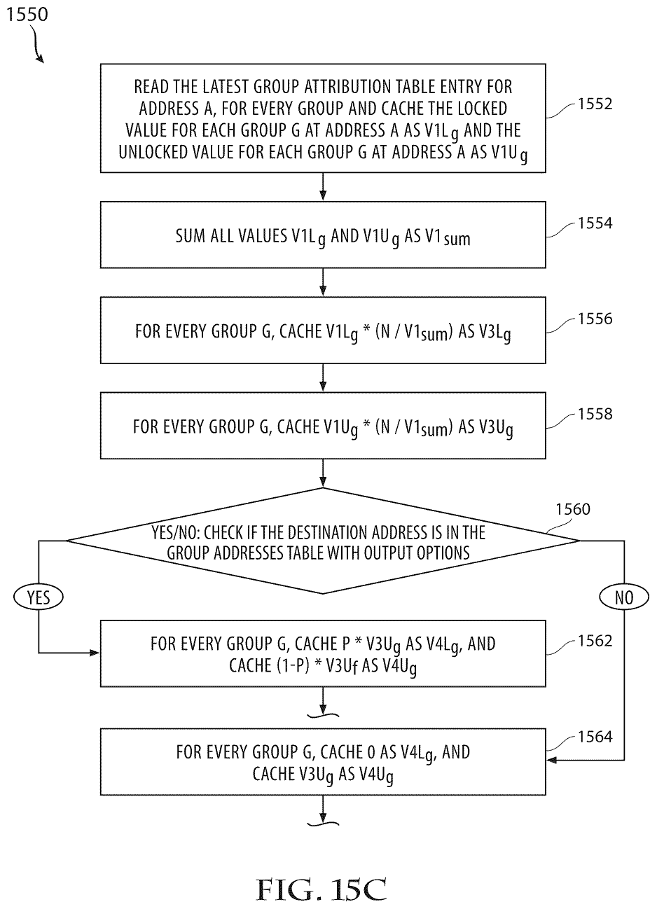

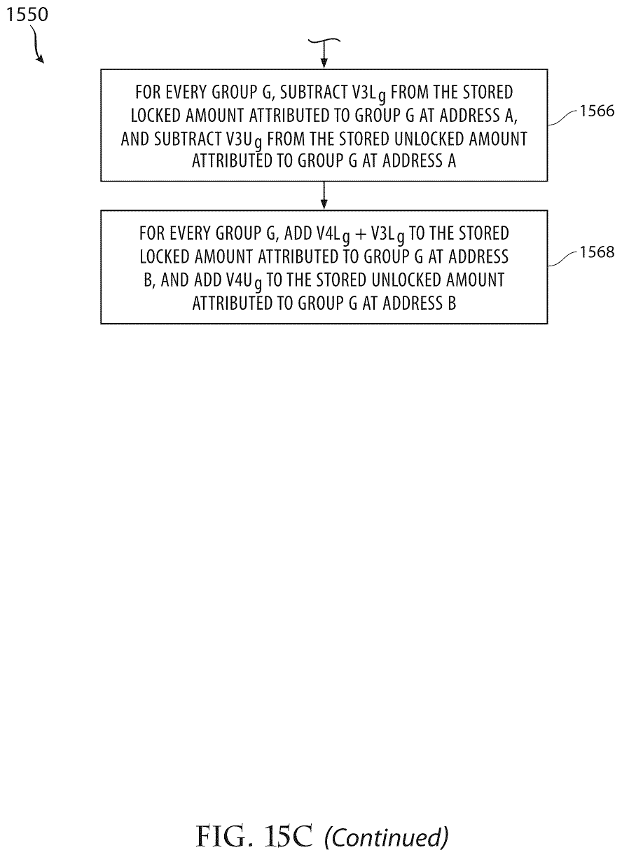

FIG. 15A is a flow diagram illustrating various re-attribution approaches 1500, in accordance with some aspects of this disclosure. These relate to the upstream and downstream methods just introduced. FIG. 15A illustrates comparable example attribution approaches using the same set of transfers for groups or tracked addresses A, B, C, D. A first approach 1502 is for an upstream re-attribution at 60% and can be unlocked.

When proposing a move of N tokens from address A to address B, where the attributed group for those tokens changes from X to Y, and P is the percentage shared upstream, the attribution system 102 can perform or apply an approach to generate attributions. P for example can be in the range [0,1]. The reattribution calculation applies a percentage (P) modifier such that the specified percentage of tokens are reattributed to the destination address owner using the upstream method. The function returns the new resulting attributions, which are keyed primarily by address, and secondarily by the group ID to which the circulation (value) is attributed. FIG. 15B illustrates an example method 1520 in this regard. The method 1520 can be performed by the attribution system 102.

In block 1522, the attribution system 102 can be configured to read the latest group attribution table entry for address A, for every group and cache the value for each group g as V1_{g}.

In block 1524, the attribution system 102 can be configured to read the latest group attribution table entry for address B, for every group and cache the value for each group g as V2_{g}.

In block 1526, the attribution system 102 can be configured to sum all values V1_{g} as V1ₛᵤₘ and sum all values V2_{g} as V2ₛᵤₘ.

In block 1528, the attribution system 102 can be configured to, for every group g, cache N*V1_{g}/V1ₛᵤₘ as V3_{g}.

In block 1530, the attribution system 102 can be configured to check if the destination address is in the group addresses table” with output options for yes/no. When the result is “yes”, go to block 1532 and when the result is “no” go to block 1534.

In block 1532, the attribution system 102 can be configured, for every group g, to cache the sum of all (P*N*V1_{g}/V1ₛᵤₘ) values as V4b. Note that V4b is used explicitly to denote the V4 value associated with group B.

In block 1534, the attribution system 102 can be configured, for every group g, to cache (P*N*V1_{g}/V1ₛᵤₘ) as V4_{g}. Note V4_{g} is used to indicate separate cached values for each group g.

In block 1536, the attribution system 102 can be configured, for every group g, to cache ((1−P)*N*(V1_{g}/V1ₛᵤₘ))) as V5_{g}.

In block 1538, the attribution system 102 can be configured, for every group g, to subtract V3_{g} from the latest group attribution table amount for address A, group g and write the result as the new latest amount for address A, group g.

In block 1540, the attribution system 102 can be configured, for every group g, to write V2_{g}+V4_{g}+V5_{g} to the latest group attribution table as the amount for address B, group g.

As is shown in the first approach, the holder D shares 40% attribution with distributor C or the attributed circulation for 40 tokens (Distributer C keeps attributed circulation for 24 of the 40 tokens). Distributor C shares 40% of the attributed circulation of 40 tokens with distributor B, or the attributed circulation for 16 tokens. Distributor B shares 40% of the attributed circulation of 16 tokens with originator A, or the attributed circulation for 6.4 tokens. The originator A keeps the remainder of the attributed circulation because there is nobody upstream. The “share 40%” between distributor B and originator A means that distributor B is sharing 40% of the remaining 16 attributed circulation (e.g., 16=100-60-24) and 40% of 16 is the 6.4 value in this example.

FIG. 15A shows a second approach 1504 for upstream re-attribution at 60%. It is worth nothing that downstream attribution requires a slight modification to the data stored. The attributed circulation retained by the group is tagged as not re-assignable (i.e., locked). This prevents the attributed circulation from being moved by later events as the tokens move through other group addresses. In this case, the amount(s) moved must be tagged as either unlocked or locked.

When proposing a move of N tokens from address A to address B, where the attributed group for those tokens changes from X to Y, and P is the percentage shared upstream, the attribution system 102 can perform the following in an example simple case of the upstream attribution algorithm.

An algorithm that performs a reattribute downstream such as in FIG. 15C performs the attribution calculation (FIG. 15A/15B) for a transfer of N tokens from source address (A) to destination address (B). The reattribution calculation applies a percentage (P) modifier such that the specified percentage of unlocked tokens are reattributed to the destination address owner using the downstream method. The function returns the new resulting attributions (locked and unlocked), which are keyed primarily by address, and secondarily by the group ID to which the circulation (value) is attributed.

FIG. 15C illustrates an upstream algorithm or method 1500. In block 1552, the attribution system 102 can be configured to read the latest group attribution table entry for address A, for every group and cache the locked value for each group g at address A as V1L_{g} and the unlocked value for each group g at address A as V1U_{g}.

In block 1554, the attribution system 102 can be configured to sum all values V1L_{g} and V1U_{g} as(V1L_{g}+V1U_{g})=V1ₛᵤₘ.

In block 1556, the attribution system 102 can be configured, for every group g, to cache N*(V11_{g}/V1ₛᵤₘ) as V3L_{g}.

In block 1558, the attribution system 102 can be configured, for every group g, cache N*(V1U_{g}/V1ₛᵤₘ) as V3U_{g}.

In block 1560, the attribution system 102 can be configured to check if the destination address is in the group addresses table with output options for yes/no. When the result is yes, the method 1500 returns to block 1562 and when the result is no, the method 1500 returns to block 1564.

In block 1562, the attribution system 102 can be configured, for every group g, to cache P*V3U_{g} as V4L_{g}, and cache (1−P)*V3U_{g} as V4U_{g}.

In block 1564, the attribution system 102 can be configured, for every group g, to cache 0 as V4L_{g}, and cache V3U_{g} as V4U_{g}.

In block 1566, the attribution system 102 can be configured, for every group g, to subtract V3L_{g} from the stored locked amount attributed to group g at address A, and subtract V3U_{g} from the stored unlocked amount attributed to group g at address A.

In block 1568, the attribution system 102 can be configured, for every group g, to add V4L_{g}+V3L_{g} to the stored locked amount attributed to group g at address B, and add V4U_{g} to the stored unlocked amount attributed to group g at address B.

FIG. 15A illustrates a third approach 1506 that covers both upstream (holder) and downstream (originator) re-attribution at 60% where the end distribution 1608 is that 40% is shared amongst all distributors which holder D gets 24%, distributor C gets 9.6%, distributor B gets 6.4%. The differences for the third approach 1506 relative to the algorithms discussed above are that 1) the attribution is locked only when transferring from the originator (i.e., not at each step as in FIG. 15C); and 2) the downstream algorithm is applied first, then the upstream algorithm is applied to the remaining unlocked portion.

In some aspects, anonymous attributions can be provided. It may be advantageous to attribute circulation to non-groups. The disclosed attribution system 102 can attribute to any address which is not associated with a group, when that address participates in the originating, distribution or transfer of the token. To achieve this, when tokens are originated or transferred through a non-group or “other” address or non-group address, the attribution system 102 can create an anonymous group ID by using the (blockchain, address) pair which is guaranteed to be globally unique.

In some aspects, cross-chain attribution can be achieved. The need for cross-chain attribution arises when the attribution system 102 sends tokens from one blockchain to another as shown in FIG. 6. In terms of events, a single cross-chain transfer of N tokens appears as two separate events: (1) A termination of N tokens on the source blockchain; (2) An origination of M tokens on the destination blockchain. If these events are not correlated, then the attributed circulation burned or terminated will be lost. The disclosed attribution system 102 correlates these two individual events by amending them with a common correlation ID. The event ordering is non-deterministic, since each event occurs on a separate chain. Therefore, the attribution system 102 handles the events correctly in either order. Note that in some cases, N tokens may be burned or terminated from one blockchain network and M tokens may be originated in a second blockchain network. The values of N and M may or may not be the same.

When a cross-chain origination is received, the attribution system 102 first checks a pending termination cache for any pending cross-chain burns or terminations. The cache is keyed by correlation ID. If a pending cross-chain termination is found for the correlation ID, the attribution system 102 pulls the attribution from that cache entry. The cross-chain origination uses that attribution.

If no pending cross-chain termination is found, the attribution system 102 uses a placeholder attribution. The placeholder attribution attributes the circulation to an unidentified single, unique placeholder ID. This placeholder ID is used as a group ID for attribution. When the placeholder attribution is created, it adds to a placeholder cache which maps correlation ID (from the cross-chain origination event) to the placeholder ID. If these tokens are moved to other wallets in the destination chain, the placeholder circulation is moved as well.

When a cross-chain termination is received, the attribution system 102 first checks the placeholder cache for the correlation ID in the termination event. If a placeholder is found, the attribution system 102 updates all addresses which hold some attribution for that placeholder ID with the actual attribution from the cross-chain burn or termination. If no placeholder is found, the attribution system 102 adds data to a pending termination cache. The pending termination cache stores the attributed circulation from the burn or termination, keyed by correlation ID.

The above-described transfer methodologies and attribution rules have an issue where an address which is receiving transferred tokens could execute two transactions sequentially to claim all attribution for themselves: 1) termination the received tokens, and 2) re-originate or re-originate the same amount of tokens. The attribution system 102 provides some mechanisms to detect and/or prevent this behavior.

To detect abusive behavior, the attribution system 102 tracks the total amount(s) burned and minted (or terminated and/or originated) by a particular group, as well as the total amount(s) transferred by a particular group. If these values track closely to one another over time, the attribution system 102 could indicate that a group was engaging in this activity where they re-originate a large portion of the tokens they are transferring.

To detect acute instances of abuse, the attribution system 102 keeps a recent history of events per-group. The recent history is limited as a sliding window of time or a fixed-size list of events. When a new event is added, the attribution system 102 scans the group-specific history to look for complementary events which would nullify the effect of the new event. When this occurs, the attribution system 102 flags it as a potential abuse case.

To prevent termination and re-origination abuse, the attribution system 102 can employ two methods: (1) The attribution system 102 can impute a termination penalty to all termination transactions, meaning that a termination and origination is a net loss. The termination penalty can come in the form of lost attributed circulation (proportional to the amount terminated), direct financial penalties, etc. The termination penalty may also be based upon the total amount terminated during a specific time period, or have increasing penalties as more tokens are terminated; (2) The attribution system 102 can provide an origination reattribution cache. When tokens are originated, the attribution system 102 can look into a recent cache of termination activity by the group doing the originating. When terminating tokens, the attribution system 102 adds the terminated attributed circulation to a time-based cache. When originating tokens, if any entries exist in the time-based cache, the originated attribution is pulled from that cache rather than being attributed to the originator.

The attribution system 102 being off-chain can provide a rollback mechanism. A benefit of the off-chain approach is that it does not need to occur live with the on-chain events which it processes. If the attribution system 102 had a bug or configuration which needed to be adjusted, events could be replayed to recompute transfers which had been previously processed. In order to accomplish this, the data storage needs to contain reference(s) which indicate whether the data is the product of transfers which will be replayed.

The attribution system 102 to enable a rollback feature includes a snapshot ID into the unique lookup key for each entry in the group attributions table or the group attributions table 228. For instance, any data written on Dec. 1, 2024 could have a snapshot ID of “2024.12.01”. When the attribution system 102 reads data from the table, the attribution system 102 sorts entries by this snapshot ID and only reads the latest entry. When the attribution system 102 writes data to the table, it encodes the current date into the snapshot ID. When new data is written the old data is not deleted. In the event of a bug introduced on Feb. 29, 2024, the attribution system 102 can remove all entries in the data table with a snapshot ID>=“2024.02.29”, then replay cached transfer events from February 29th and later.

This approach gives flexibility between data storage requirements and the replay granularity. For instance, if one wanted finer granularity (by the hour), the attribution system 102 could append the hour (ie: YYYY.MM.DD.HH) at the cost of more required storage. This approach may lead to some snapshot IDs having almost no associated data (periods of low activity) and other snapshot IDs having lots of activity.

To give a more predictable number of updates per snapshot ID, the attribution system 102 could also use a value which increases by 1 every N events. For example, in some aspects, the attribution system 102 can use Kafka to receive transfers, and Kafka has an always increasing offset. The snapshot ID could merely be floor (offset/K) where K is the number of transfers included in each snapshot ID. This limits the number of events which would need to be replayed to regenerate a given snapshot ID.

To reduce the storage requirement while retaining finer granularity, the attribution system 102 includes a cleanup job could remove older data which meets some or all of the following criteria: (1) The data is older than we would feasibly use for a rollback; (2) The data is overshadowed by a newer snapshot ID which we would also not feasibly delete as part of a rollback. This cleanup keeps the data storage requirements from growing unbounded.

The type of data that can be tracked via the principles disclosed herein can include data associated with any entity such as groups who originate or enable the transfer of tokenized assets to different individuals, or may include bad actors who the attribution system 102 desires to track. Thus, in addition to attributing tokens to the group(s) responsible for their circulation, the disclosed system can also track other data related to the movement of tokens between their origination and burn or termination.

Each time a token is involved in a transaction which moves it from one address to another, the attribution system 102 can increment a transaction counter for the token. The transaction counter becomes the count of the number of transactions the token has been involved in for its lifetime. In cases where the attribution system 102 distinctly tracks groups of tokens with respect to historical ordering in each address, the attribution system 102 can increment the transaction counter directly without any averaging (i.e., the TokenData is moved from the source to the destination). In cases where the attribution system 102 aggregates token amounts per group (i.e., Map<GroupId, TokenData>vs Stack<Map<GroupId, TokenData>>) the attribution system 102 can increment the count by the total number of tokens moved and incorporate that into a weighted average.

Specifically for each transfer TO an address, the following pseudocode can apply:

| 1 | map[destAddr].TokenData[groupId].AvgTransferCount += ( | |
|---|---|---|
| 2. | (map[destAddr].TokenData[groupId].AvgTransferCount * | |
| 3. | map[destAddr].TokenData[groupId].Amount) + | |
| 4. | ((map[sourceAddr].TokenData[groupId].AvgTransferCount + 1) * | |
| 5. | Transfer[groupId].Amount)) / 2 | |
| 6. | map[destAddr].TokenData[groupId].Amount += Transfer[groupId].Amount | |
| 7. | and for each transfer FROM an address (no change to weighted average): | |
| | 8. | map[sourceAddr].TokenData[groupId].Amount −= |
| | 9. | Transfer[groupId].Amount |

Note in the above that line 4 above includes the +1 term which is what increments the count for each transaction. When a token is originated, the attribution system 102 records the origination time as a timestamp, block height, or some other historical reference. The token age can thus be tracked. By recording such data at the time of origination, it gives the age of these tokens when compared to the current time (or the time they are burned or terminated).

A method of tracking age follows the transaction count calculations above, using a weighted average age. The attribution system 102 can make no change to the average for each transfer FROM an address or when tokens are burned or terminated. When tokens are originated into an address, pseudocode can include the following:

$$map [ destAddr ] . TokenData [ groupId ] . AvgTokenAge += ( ( map [ destAddr ] . TokenData [ groupId ] . AvgTokenAge * map [ destAddr ] . \text{} TokenData [ groupId ] . Amount ) + ( Time . Now ( ) * Mint . Amount ) ) / 2$$

$$map [ destAddr ] . TokenData [ groupId ] . Amount += Event . Amount$$

For each transfer TO an address, the attribution system 102 can perform the following pseudocode for each group whose attributed circulation is being transferred:

$$map [ destAddr ] . TokenData [ groupId ] . AvgTokenAge += ( ( map [ destAddr ] . TokenData [ groupId ] . AvgTokenAge * map [ destAddr ] . TokenData [ groupId ] . Amount ) + ( map [ sourceAddr ] . TokenData [ groupId ] . AvgTokenAge ) * Transfer [ groupId ] . Amount ) ) / 2$$

$$map [ destAddr ] . TokenData [ groupId ] . Amount += Transfer [ groupId ] . Amount$$

Another benefit supported by off-chain attribution is retrofitting. A benefit of off-chain attribution (compared to on-chain attribution) is that it can be retrofitted to any existing token, without modifying that token's on-chain behavior, such as the smart contract. To retrofit off-chain attribution to an existing token, we need to bring the group attributions table or circulation snapshot table 228 up-to-date to process new events. The attribution system 102 can include the following to accomplish this: (1) Replay the entire on-chain history. Since all events are stored as prior events in the chain, the attribution system 102 can replay these events in order starting from an empty table. At some point, scale may be prohibitive to this approach; (2) Snapshot current balances, and attribute to “unknown” group. To avoid the overhead of replaying a long history of events, an alternate approach is to start from a current snapshot of balances at each address (from a blockchain data provider). The information missing from such a snapshot would be the breakdown of what has been attributed to each group at each address. To accomplish this, the attribution system 102 attributes everything in an address to an “unknown” group. When a transaction occurs to a group-owned address, any attribution assigned to an “unknown” group is automatically re-attributed to the recipient of the transfer.

A “land grab” scenario may occur shortly after the snapshot is taken, where transfers shortly after the snapshot disproportionately credit unattributed circulation. There are a few approaches to mitigate this: a) per-group reattribution caps or b) limiting the percentage which is reattributed in a single transaction. The per-group reattribution cap may limit the rate or total amount which can be reattributed to each group. Limiting the percentage which is reattributed in a single transaction may be applied with a static percentage for all transactions, or the attribution system 102 can keep a per-group percentage which decreases (linearly, exponentially, etc.) with each transaction.

There are a number of innovations described herein that relate to on-chain systems, off-chain systems or other types of systems that are independent of a blockchain network and can apply to any transactions. In some cases, some innovations are dependent on being related to a blockchain network and other innovations are independent of a blockchain network or more specifically on off-chain attribution approach. For example, the sequence of attribution stages discussed above can relate to both an on-chain system or an off-chain system as well as to any type of network configuration. The various transfer methodologies also can relate to both an on-chain system or an off-chain system as well as to any type of network configuration. The concepts of partial attribution, locked attribution and avoiding unfair reattribution with group caps or limits can each relate to both an on-chain system or an off-chain system as well as to any type of network configuration.

The following concepts are typically only applicable to the off-chain attribution system: (1) lossless cross-chain attribution; (2) using a snapshot ID for granular rollback; (3) using balances snapshot for retrofitting; (4) reattributing unknown attribution. Notwithstanding this list, these concepts may also apply in some respects to an on-chain system or to other network transaction types.

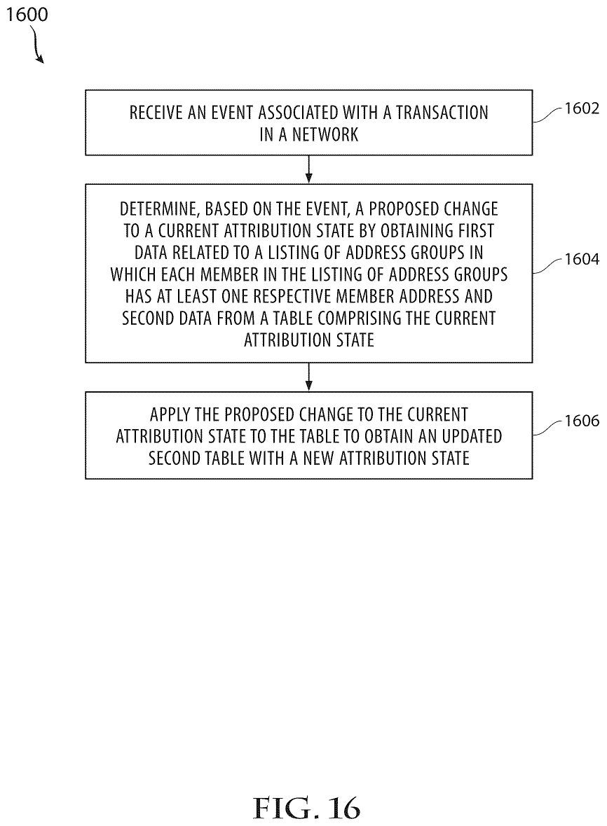

FIG. 16 illustrates an example method 1600 of generating attribution data based on transactions in a network. In some cases, the attribution system 102 can include a scenario where a set of group addresses is passed in a request to the attribution system 102. The set of group addresses can be included in the request rather than being stored in a table or any other data storage. In one example, the process 1600 can be performed by one or more of an attribution system 102, a transaction system 106, a blockchain network 108, a smart contract 110, a blockchain event service 302, a cross-chain service 208, a attribution service 204, a cloud storage service 230, a data layer 222, a computing system 1800, at least one processor 1810 of the computing system 1800, and/or a combination thereof.

At operation 1602, an apparatus or system (e.g., the attribution system 102, the transaction system 106, the blockchain network 108, the smart contract 110, the blockchain event service 302, the cross-chain service 208, the attribution service 204, the cloud storage service 230, the data layer 222, the computing system 1800, at least one processor 1810 of the computing system 1800, and/or a combination thereof) can be configured to receive an event associated with a transaction in a network.

At operation 1604, an apparatus or system (e.g., the attribution system 102, the transaction system 106, the blockchain network 108, the smart contract 110, the blockchain event service 302, the cross-chain service 208, the attribution service 204, the cloud storage service 230, the data layer 222, the computing system 1800, at least one processor 1810 of the computing system 1800, and/or a combination thereof) can be configured to determine, based on the event, a proposed change to a group attribution state by obtaining first data related to a listing of group addresses in which each member in the listing of group addresses has at least one respective member address and second data from a table comprising the group attribution state. The first data can be passed in a request. In another aspect, the event can flag whether an address is tracked and stored in an address table. When the flag indicates that one or more addresses are not tracked, then the attribution system 102 does not need to read any table for an address.

At operation 1606, an apparatus or system (e.g., the attribution system 102, the transaction system 106, the blockchain network 108, the smart contract 110, the blockchain event service 302, the cross-chain service 208, the attribution service 204, the cloud storage service 230, the data layer 222, the computing system 1800, at least one processor 1810 of the computing system 1800, and/or a combination thereof) can be configured to apply the proposed change to the group attribution state to the table to obtain an updated second table with a new attribution state.

In some aspects, an apparatus is disclosed for generating attribution data associated with transactions, the apparatus can include at least one memory; and at least one processor coupled to the at least one memory and configured to: receive an event associated with a transaction in a network; determine, based on the event, a proposed change to a group attribution state by obtaining first data related to a listing of group addresses in which each member in the listing of group addresses has at least one respective member address and second data from a table comprising the group attribution state; and apply the proposed change to the group attribution state to the table to obtain an updated second table with a new attribution state.

In some aspects, a computer-readable storage medium is disclosed which stores instructions, which, when executed by a processor, cause the processor to be configured to: receive an event associated with a transaction in a network; determine, based on the event, a proposed change to a group attribution state by obtaining first data related to a listing of group addresses in which each member in the listing of group addresses has at least one respective member address and second data from a table comprising the group attribution state; and apply the proposed change to the group attribution state to the table to obtain an updated second table with a new attribution state.

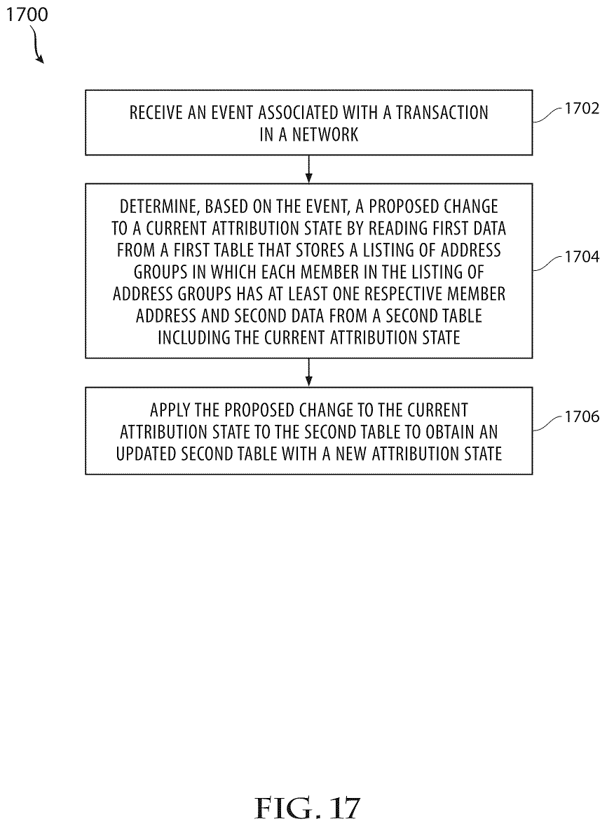

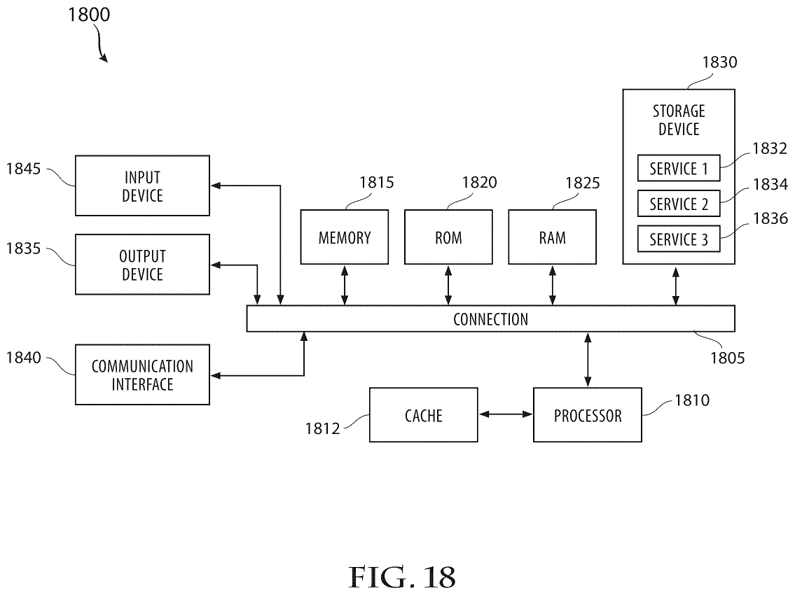

FIG. 17 illustrates a process 1700 for generating attribution data based on transactions in a network. In one example, the process 1700 can be performed by one or more of an attribution system 102, a transaction system 106, a blockchain network 108, a smart contract 110, a blockchain event service 302, a cross-chain service 208, a attribution service 204, a cloud storage service 230, a data layer 222, a computing system 1800, at least one processor 1810 of the computing system 1800, and/or a combination thereof. For instance, a computing device with the computing device architecture of the computing system 1800 shown in FIG. 18 can implement the operations of FIG. 17 and/or the components and/or operations described herein with respect to any of FIGS. 1-16.

At operation 1702, an apparatus or system (e.g., the attribution system 102, the transaction system 106, the blockchain network 108, the smart contract 110, the blockchain event service 302, the cross-chain service 208, the attribution service 204, the cloud storage service 230, the data layer 222, the computing system 1800, at least one processor 1810 of the computing system 1800, and/or a combination thereof.) and be configured to receive an event associated with a transaction in a network. The approach relates to the use of attribution data and the mechanism of generating the data itself. The generation of the data can be used for attributing benefits or perhaps tracking bad behavior. For instance, there may be a use case which is not attributing benefits, but the attribution system 102 can be configured to track blame for bad actions or measure certain behaviors. An example as described herein can include attributing circulation to be used in calculating benefits or rewards. In the broadest sense, a single event is received but in practice the attribution system 102 would receive one or more event and likely many events to be tracked.

The event can include one or more of a data type, a source address, a destination address, an amount, a blockchain network identifier, a timestamp, a state, and a token. In some aspects, the data type may include one or more of a originating of a token, a burning or terminating of a token, a transfer of a token, a cross-chain transaction for a token and wherein the token comprises a tokenized asset. The event may include a cross-chain transfer of N tokens. For example, the cross-chain transfer of N tokens may include a termination of first N tokens from a source chain and a mint or origination of second M tokens on a destination chain and wherein the proposed change to the group attribution state to the second table to obtain the updated second table with the new attribution state takes into account the termination of the first N tokens from the source chain and the mint or origination of the second M tokens on the destination chain. The values of N and M may be the same (such as one hundred tokens are terminated and one hundred tokens are originated), or these values may be different and the types of tokens may be the same or different as well. The process may include terminating ten tokens on first blockchain and then originating twenty tokens on a second blockchain.

The second table can further include data such as a transaction count associated with a token or tokenized asset related to the event. The second table may include a count of a number of transactions the tokenized asset is involved in and the age of the tokenized asset since originating.

In some aspects, the event can include a transfer of a portion of an attributed circulation from an address or a selection of a transfer methodology from a list of transfer methodologies comprising: a first approach based on historical ordering, a second approach based on proportional to attributed circulation, a third approach equally split across groups, a fourth approach based on group characteristics, a fifth approach based on destination address, a sixth approach based on a randomly selected group and a seventh approach based on discrepancies between a source address and a destination address.

At operation 1704, an apparatus or system (e.g., the attribution system 102, the transaction system 106, the blockchain network 108, the smart contract 110, the blockchain event service 302, the cross-chain service 208, the attribution service 204, the cloud storage service 230, the data layer 222, the computing system 1800, at least one processor 1810 of the computing system 1800, and/or a combination thereof.) and be configured to determine, based on the event, a proposed change to a group attribution state by reading first data from a first table that stores a listing of group addresses in which each member in the listing of group addresses has at least one respective member address and second data from a second table comprising the group attribution state. Each entity in an address group can have one or more addresses. For example, a group may have one or more addresses in the listing of group addresses.

Group addresses can relate to groups as described above or to other entities. A grouping mechanism is used for a set of one or more addresses. An “address group” can refer to groups or may refer to a group of known bad actor addresses. The attribution system 102 can then track the circulation attributed to the entities in the address group whether they are groups, bad actors, contributors, or other types of entities.

At operation 1706, an apparatus or system (e.g., the attribution system 102, the transaction system 106, the blockchain network 108, the smart contract 110, the blockchain event service 302, the cross-chain service 208, the attribution service 214, the cloud storage service 230, the data layer 222, the computing system 1800, at least one processor 1810 of the computing system 1800, and/or a combination thereof.) and be configured to apply the proposed change to the group attribution state to the second table to obtain an updated second table with a new attribution state.

The “network” can refer to a blockchain network 108 in some aspects or may refer to a more traditional computer network. In some aspects, when the network is the blockchain network 108, the process 1700 may operate off-chain relative to the blockchain network 108, while in other aspects, the process 1700 may operate on-network via a smart contract 110.

In some aspects, the second table may include the group attribution state further having a snapshot identifier for each entry in the second table, the snapshot identifier enabling a sorting of data in the second table, a filtering of data in the second table, or a separate action associated with the data in the second table. The snapshot identifier may include at least one of a date, a time, a value and an incremental value every N transfers.

The process 1700 may further include performing at least one of: replaying events in the blockchain network to populate the second table and bringing the second table up to date to begin processing new events from the blockchain network. The table does not need to be empty as a requirement for replaying events. For instance, the table may contain data for thirty days or days 1-30. The attribution system 102 could replay events starting at day sixteen. The attribution system 102 could remove all entries with a snapshot ID>=sixteen and then replay the events from day sixteen onward.

In some aspects, the process 1700 can further include receiving, from a blockchain data provider, a current snapshot of balances at each address; attributing a respective transaction for a respective address to an unknown entity or group; and when a new transaction occurs to a tracked address as identified from the first table, re-attributing the new transaction to the tracked address such that the new attribution state includes the tracked address.

In some aspects, a mitigation algorithm cam be implemented by the attribution system 102 to prevent a disproportionate attribution to groups for transactions occurring shortly after the current snapshot of balances at each address.

In some aspects, the process 1700 can further include: recording relevant changes associated with the new attribution state to an audit log; deduplicating the event to sure that it has not already been processed; extracting the group attribution state by reading from the first table and the second table; and caching an acknowledgement of the event as having been processed for a later deduplication stage.

In some aspects, the proposed change is determined based on rules that determine how much of an attributed circulation is shared by groups, wherein the rules specify at least one of a modifier, a matcher, an exclusivity and an algorithm. In some aspects, wherein when the rules specify the use of the algorithm, the algorithm includes one of an upstream algorithm in which a first configured modifier related to a first modified amount is shared with an upstream entity or a downstream algorithm in which a second configured modifier related to a second modified amount is shared with a downstream entity.

When the algorithm is the downstream algorithm, the process 1700 further can include: associating an attributed circulation to the downstream entity as locked to prevent the attributed circulation from being moved by later events.

The process 1700 can further include receiving a current snapshot of balances at each address; attributing a respective transaction for a respective address to an unknown group; and, when a new transaction occurs to a tracked address as identified from the first table, re-attributing the new transaction to the tracked address such that the new attribution state includes the tracked address and according to one of a per-entity re-attribution cap or a limit to a percentage applied to a single transaction to avoid disproportionate credit re-attribution for transactions after the current snapshot. Further, the process 1700 can include utilizing a time-based cache such that, when originating a tokenized asset, if an entry related to a originated attribution is stored in the time-based cache, the originated attribution is obtained from the time-based cache rather than being attributed to a originator of the new tokenized asset. When tokens are originated, the attribution system 102 can look into a recent cache of termination activity by the group doing the originating. When terminating tokens, the attribution system 102 adds the terminated attributed circulation to a time-based cache.

In some aspects, an apparatus for generating attribution data associated with transactions, the apparatus including at least one memory; and at least one processor coupled to the at least one memory and configured to: receive an event associated with a transaction in a network; determine, based on the event, a proposed change to a group attribution state by reading first data from a first table that stores a listing of group addresses in which each member in the listing of group addresses has at least one respective member address and second data from a second table comprising the group attribution state; and apply the proposed change to the group attribution state to the second table to obtain an updated second table with a new attribution state.

In some aspects, a computer-readable storage medium storing instructions, which, when executed by a processor, cause the processor to be configured to: receive an event associated with a transaction in a network; determine, based on the event, a proposed change to a group attribution state by reading first data from a first table that stores a listing of group addresses in which each member in the listing of group addresses has at least one respective member address and second data from a second table comprising the group attribution state; and apply the proposed change to the group attribution state to the second table to obtain an updated second table with a new attribution state.

FIG. 18 is a diagram illustrating an example of a system for implementing certain aspects of the present disclosure. In particular, FIG. 18 illustrates an example of computing system 1800, which can be for example any computing device making up a computing system, a point-of-sale system, or any component thereof in which the components of the attribution system 102 are in communication with each other using connection 1805. Connection 1805 can be a physical connection using a bus, or a direct connection into processor 1810, such as in a chipset architecture. Connection 1805 can also be a virtual connection, networked connection, or logical connection.

In some examples, computing system 1800 is a distributed system in which the functions described in this disclosure can be distributed within a datacenter, multiple data centers, a peer network, etc. In some examples, one or more of the described system components represents many such components each performing some or all of the function for which the component is described. In some examples, the components can be physical or virtual devices.

Example system 1800 includes at least one processing unit (CPU or processor) 1810 and connection 1805 that couples various system components including system memory 1815, such as read-only memory (ROM) 1820 and random access memory (RAM) 1825 to processor 1810. Computing system 1800 can include a cache 1812 of high-speed memory connected directly with, in close proximity to, or integrated as part of processor 1810.

Processor 1810 can include any general-purpose processor and a hardware service or software service, such as services 1832, 1834, and 1836 stored in storage device 1830, configured to control processor 1810 as well as a special-purpose processor where software instructions are incorporated into the actual processor design. Processor 1810 may essentially be a completely self-contained computing system, containing multiple cores or processors, a bus, memory controller, cache, etc. A multi-core processor may be symmetric or asymmetric.

To enable user interaction, computing system 1800 includes an input device 1845, which can represent any number of input mechanisms, such as a microphone for speech, a touch-sensitive screen for gesture or graphical input, keyboard, mouse, motion input, speech, etc. Computing system 1800 can also include output device 1835, which can be one or more of a number of output mechanisms. In some instances, multimodal systems can enable a user to provide multiple types of input/output to communicate with computing system 1800. Computing system 1800 can include communications interface 1840, which can generally govern and manage the user input and system output.

The communication interface may perform or facilitate receipt and/or transmission wired or wireless communications using wired and/or wireless transceivers, including those making use of an audio jack/plug, a microphone jack/plug, a universal serial bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a radio-frequency identification (RFID) wireless signal transfer, near-field communications (NFC) wireless signal transfer, dedicated short range communication (DSRC) wireless signal transfer, 1202.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof.

The communications interface 1840 may also include one or more Global Navigation Satellite System (GNSS) receivers or transceivers that are used to determine a location of the computing system 1800 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 1830 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (L1/L2/L3/L4/L5/L #), resistive random-access memory (RRAM/ReRAM), phase change memory (PCM), spin transfer torque RAM (STT-RAM), another memory chip or cartridge, and/or a combination thereof.

The storage device 1830 can include software services, servers, services, etc., that when the code that defines such software is executed by the processor 1810, it causes the attribution system 102 to perform a function. In some examples, a hardware service that performs a particular function can include the software component stored in a computer-readable medium in connection with the necessary hardware components, such as processor 1810, connection 1805, output device 1835, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

In some aspects the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Specific details are provided in the description above to provide a thorough understanding of the aspects and examples provided herein. However, it will be understood by one of ordinary skill in the art that the aspects may be practiced without these specific details. For clarity of explanation, in some instances the present technology may be presented as including individual functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general-purpose computer, special purpose computer, or a processing device to perform a certain function or group of functions. Portions of computer resources used can be accessible over a network. The computer executable instructions may be, for example, binaries, intermediate format instructions such as assembly language, firmware, source code. Examples of computer-readable media that may be used to store instructions, information used, and/or information created during methods according to described examples include magnetic or optical disks, flash memory, USB devices provided with non-volatile memory, networked storage devices, and so on.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rack-mounted devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific aspects thereof, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

The various illustrative logical blocks, modules, circuits, and algorithm steps described in connection with the examples disclosed herein may be implemented as electronic hardware, computer software, firmware, or combinations thereof. To clearly illustrate the interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, then the techniques may be realized at least in part by a computer-readable data storage medium comprising program code including instructions that, when executed, performs one or more of the methods, algorithms, and/or operations described above. The computer-readable data storage medium may form part of a computer program product, which may include packaging materials. The computer-readable medium may comprise memory or data storage media, such as random-access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

Illustrative clauses of the present disclosure include:

Clause 1. An apparatus for generating attribution data associated with transactions, the apparatus comprising:
at least one memory; and
at least one processor coupled to the at least one memory and configured to:
receive an event associated with a transaction in a network;
determine, based on the event, a proposed change to a group attribution state by reading first data from a first table that stores a listing of group addresses in which each member in the listing of group addresses has at least one respective member address and second data from a second table comprising the group attribution state; and
apply the proposed change to the group attribution state to the second table to obtain an updated second table with a new attribution state.

Clause 2. The apparatus of Clause 1, wherein the network comprises a blockchain network and wherein the apparatus operates off-chain relative to the blockchain network.

Clause 3. The apparatus of any previous clause, wherein the event comprises one or more of a data type, a source address, a destination address, an amount, a blockchain network identifier, a timestamp, a state, and a token.

Clause 4. The apparatus of any previous clause, wherein the data type comprises one or more of a originating of a token, a terminating of a token, a transfer of a token, a cross-chain transaction for a token and wherein the token comprises a tokenized asset.

Clause 5. The apparatus of any previous clause, wherein the cross-chain transfer of N tokens comprises a termination of first N tokens from a source chain and a mint or origination of second M tokens on a destination chain and wherein the proposed change to the group attribution state to the second table to obtain the updated second table with the new attribution state takes into account the termination of the first N tokens from the source chain and the mint or origination of the second M tokens on the destination chain.

Clause 6. The apparatus of any previous clause, wherein the second table comprising the group attribution state further comprises a snapshot identifier for each entry in the second table, the snapshot identifier enabling a sorting of data in the second table, a filtering of data in the second table, or a separate action associated with the data in the second table.

Clause 7. The apparatus of any previous clause, wherein the snapshot identifier comprises at least one of a date, a time, a value and an incremental value every N transfers.

Clause 8. The apparatus of any previous clause, wherein the at least one processor coupled to the at least one memory is configured to: perform at least one of: replaying events in the blockchain network to populate the second table and bringing the second table up to date to begin processing new events from the blockchain network.

Clause 9. The apparatus of any previous clause, wherein the at least one processor coupled to the at least one memory is configured to:
receive, from a blockchain data provider, a current snapshot of balances at each address;
attribute a respective transaction for a respective address to an unknown group; and
when a new transaction occurs to the at least one respective member address as identified from the first table, re-attribute the new transaction to the at least one respective member address such that the new attribution state includes the at least one respective member address.

Clause 10. The apparatus of any previous clause, wherein a mitigation algorithm prevents a disproportionate attribution to groups for transactions occurring shortly after the current snapshot of balances at each address.

Clause 11. The apparatus of any previous clause, wherein the at least one processor coupled to the at least one memory and configured to:
deduplicate the event to sure that it has not already been processed;
record relevant changes associated with the new attribution state to an audit log;
extract the group attribution state by reading from the first table and the second table; and
cache an acknowledgement of the event as having been processed for a later deduplication stage.

Clause 12. The apparatus of any previous clause, wherein when the event comprises a transfer of a portion of an attributed circulation from an address, the apparatus further configured to select a transfer methodology from a list of transfer methodologies comprising: a first approach based on historical ordering, a second approach based on proportional to attributed circulation, a third approach equally split across groups, a fourth approach based on group characteristics, a fifth approach based on destination address, a sixth approach based on a randomly selected group and a seventh approach based on discrepancies between a source address and a destination address.

Clause 13. The apparatus of any previous clause, wherein the proposed change is determined based on rules that determine how much of an attributed circulation is shared by groups, wherein the rules specify at least one of a modifier, a matcher, an exclusivity and an algorithm.

Clause 14. The apparatus of any previous clause, wherein the algorithm comprises one of an upstream algorithm in which a first configured modifier related to a first modified amount is shared with an upstream entity or a downstream algorithm in which a second configured modifier related to a second modified amount is shared with a downstream entity.

Clause 15. The apparatus of any previous clause, wherein, when the algorithm comprises the downstream algorithm, the at least one processor coupled to the at least one memory and configured to:
associate an attributed circulation to the downstream entity as locked to prevent the attributed circulation from being moved by later events.

Clause 16. The apparatus of any previous clause, wherein the second table further stores at least one of a transaction count per event and a token age per token associated with the event and wherein the at least one processor coupled to the at least one memory is configured to:
utilize a time-based cache such that, when originating a tokenized asset, if an entry related to a originated attribution is stored in the time-based cache, the originated attribution is obtained from the time-based cache rather than being attributed to a originator of the new tokenized asset.

Clause 17. The apparatus of any previous clause, wherein the at least one processor coupled to the at least one memory is configured to:
receive a current snapshot of balances at each address;
attribute a respective transaction for a respective address to an unknown group; and
when a new transaction occurs to the at least one respective member address as identified from the first table, re-attribute the new transaction to the at least one respective member address such that the new attribution state includes the at least one respective member address and according to one of a per-entity re-attribution cap or a limit to a percentage applied to a single transaction to avoid disproportionate credit re-attribution for transactions after the current snapshot.

Clause 18. A method for generating attribution data associated with transactions, the method comprising:
receiving an event associated with a transaction in a network;
determining, based on the event, a proposed change to a group attribution state by reading first data from a first table that stores a listing of group addresses in which each member in the listing of group addresses has at least one respective member address and second data from a second table comprising the group attribution state; and applying the proposed change to the group attribution state to the second table to obtain an updated second table with a new attribution state.

Clause 19. The method of Clause 18, wherein the network comprises a blockchain network and wherein the method operates off-chain relative to the blockchain network.

Clause 20. The method of any of clauses 18-19, wherein the event comprises one or more of a data type, a source address, a destination address, an amount, a blockchain network identifier, a timestamp, a state, and a token.

Clause 21. The method of any of clauses 18-20, wherein the data type comprises one or more of a originating of a token, a terminating of a token, a transfer of a token, a cross-chain transaction for a token and wherein the token comprises a tokenized asset.

Clause 22. The method any of clauses 18-21, wherein the cross-chain transfer of N tokens comprises a termination of first N tokens from a source chain and a mint or origination of second M tokens on a destination chain and wherein the proposed change to the group attribution state to the second table to obtain the updated second table with the new attribution state takes into account the termination of the first N tokens from the source chain and the mint or origination of the second M tokens on the destination chain.

Clause 23. The method of any of clauses 18-22, wherein the second table comprising the group attribution state further comprises a snapshot identifier for each entry in the second table, the snapshot identifier enabling a sorting of data in the second table, a filtering of data in the second table, or a separate action associated with the data in the second table.

Clause 24. The method of any of clauses 18-23, wherein the snapshot identifier comprises at least one of a date, a time, a value and an incremental value every N transfers.

Clause 25. The method of any of clauses 18-24, further comprising:
performing at least one of: replaying events in the blockchain network to populate the second table and bringing the second table up to date to begin processing new events from the blockchain network.

Clause 26. The method of any of clauses 18-25, further comprising:
receiving, from a blockchain data provider, a current snapshot of balances at each address;
attributing a respective transaction for a respective address to an unknown group; and
when a new transaction occurs to the at least one respective member address as identified from the first table, re-attributing the new transaction to the at least one respective member address such that the new attribution state includes the at least one respective member address.

Clause 27. The method of any of clauses 18-26, wherein a mitigation algorithm prevents a disproportionate attribution to groups for transactions occurring shortly after the current snapshot of balances at each address.

Clause 28. The method of any of clauses 18-27, further comprising:
deduplicating the event to sure that it has not already been processed;
recording relevant changes associated with the new attribution state to an audit log;
extracting the group attribution state by reading from the first table and the second table; and
caching an acknowledgement of the event as having been processed for a later deduplication stage.

Clause 29. The method of any of clauses 18-28, wherein when the event comprises a transfer of a portion of an attributed circulation from an address, the method further comprising selecting a transfer methodology from a list of transfer methodologies comprising: a first approach based on historical ordering, a second approach based on proportional to attributed circulation, a third approach equally split across groups, a fourth approach based on group characteristics, a fifth approach based on destination address, a sixth approach based on a randomly selected group and a seventh approach based on discrepancies between a source address and a destination address.

Clause 30. The method of any of clauses 18-29, wherein the proposed change is determined based on rules that determine how much of an attributed circulation is shared by groups, wherein the rules specify at least one of a modifier, a matcher, an exclusivity and an algorithm.

Clause 31. The method of any of clauses 18-30, wherein the algorithm comprises one of an upstream algorithm in which a first configured modifier related to a first modified amount is shared with an upstream entity or a downstream algorithm in which a second configured modifier related to a second modified amount is shared with a downstream entity.

Clause 32. The method of any of clauses 18-31, wherein, when the algorithm comprises the downstream algorithm, the method further comprising:
associating an attributed circulation to the downstream entity as locked to prevent the attributed circulation from being moved by later events.

Clause 33. The method of any of clauses 18-32, wherein the second table further stores at least one of a transaction count per event and a token age per token associated with the event and wherein the method further comprises:
utilizing a time-based cache such that, when originating a tokenized asset, if an entry related to a originated attribution is stored in the time-based cache, the originated attribution is obtained from the time-based cache rather than being attributed to a originator of the new tokenized asset.

Clause 34. The method of any of clauses 18-33, wherein the method further comprises:
receiving a current snapshot of balances at each address;
attributing a respective transaction for a respective address to an unknown group; and
when a new transaction occurs to a tracked address as identified from the first table, re-attributing the new transaction to the tracked address such that the new attribution state includes the tracked address and according to one of a per-entity re-attribution cap or a limit to a percentage applied to a single transaction to avoid disproportionate credit re-attribution for transactions after the current snapshot.

Clause 35. A computer-readable storage medium storing instructions, which, when executed by a processor, cause the processor to be configured to:
receive an event associated with a transaction in a network;
determine, based on the event, a proposed change to a group attribution state by reading first data from a first table that stores a listing of group addresses in which each member in the listing of group addresses has at least one respective member address and second data from a second table comprising the group attribution state; and
apply the proposed change to the group attribution state to the second table to obtain an updated second table with a new attribution state.

Clause 36. An apparatus for generating attribution data associated with transactions, the apparatus comprising:
at least one memory; and
at least one processor coupled to the at least one memory and configured to:
   receive an event associated with a transaction in a network;
   determine, based on the event, a proposed change to a group attribution state by obtaining first data related to a listing of group addresses in which each member in the listing of group addresses has at least one respective member address and second data from a table comprising the group attribution state; and
   apply the proposed change to the group attribution state to the table to obtain an updated second table with a new attribution state.

Clause 37. The apparatus of Clause 36, wherein the first data is passed in a request.

Clause 38. The apparatus of Clause 36, wherein the event flags whether an address is tracked and stored in an address table.

Clause 39. A method for generating attribution data associated with transactions, the method comprising:
receiving an event associated with a transaction in a network;
determining, based on the event, a proposed change to a group attribution state by obtaining first data related to a listing of group addresses in which each member in the listing of group addresses has at least one respective member address and second data from a table comprising the group attribution state; and
applying the proposed change to the group attribution state to the table to obtain an updated second table with a new attribution state.

Clause 40. The method of Clause 39, wherein the first data is passed in a request.

Clause 41. The method of Clause 39, wherein the event flags whether an address is tracked and stored in an address table.

Clause 42. A computer-readable storage medium storing instructions, which, when executed by a processor, cause the processor to be configured to:
receive an event associated with a transaction in a network;
determine, based on the event, a proposed change to a group attribution state by obtaining first data related to a listing of group addresses in which each member in the listing of group addresses has at least one respective member address and second data from a table comprising the group attribution state; and
apply the proposed change to the group attribution state to the table to obtain an updated second table with a new attribution state.

Clause 43. The computer-readable storage medium of Clause 42, wherein the first data is passed in a request.

Clause 44. The computer-readable storage medium of Clause 42, wherein the event flags whether an address is tracked and stored in an address table.

What is claimed is:

1. An apparatus for generating attribution data associated with transactions, the apparatus comprising:
at least one memory; and
at least one processor coupled to the at least one memory and configured to:
receive an event associated with a transaction in a network;
determine, based on the event, a proposed change to a group attribution state by reading first data from a first table that stores a listing of group addresses in which each member in the listing of group addresses has at least one respective member address and second data from a second table comprising the group attribution state; and
apply the proposed change to the group attribution state to the second table to obtain an updated second table with a new attribution state.

2. The apparatus of claim 1, wherein the network comprises a blockchain network and wherein the apparatus operates off-chain relative to the blockchain network.

3. The apparatus of claim 1, wherein the event comprises one or more of a data type, a source address, a destination address, an amount, a blockchain network identifier, a timestamp, a state, and a token.

4. The apparatus of claim 3, wherein the data type comprises one or more of an originating of a token, a terminating of a token, a transfer of a token, a cross-chain transaction for a token and wherein the token comprises a tokenized asset.

5. The apparatus of claim 4, wherein the cross-chain transfer of N tokens comprises a termination of first N tokens from a source chain and an origination of second M tokens on a destination chain and wherein the proposed change to the group attribution state to the second table to obtain the updated second table with the new attribution state takes into account the termination of the first N tokens from the source chain and the origination of the second M tokens on the destination chain.

6. The apparatus of claim 2, wherein the second table comprising the group attribution state further comprises a snapshot identifier for each entry in the second table, the snapshot identifier enabling a sorting of data in the second table, a filtering of data in the second table, or a separate action associated with the data in the second table.

7. The apparatus of claim 6, wherein the snapshot identifier comprises at least one of a date, a time, a value and an incremental value every N transfers.

8. The apparatus of claim 2, wherein the at least one processor coupled to the at least one memory is configured to: perform at least one of: replaying events in the blockchain network to populate the second table and bringing the second table up to date to begin processing new events from the blockchain network.

9. The apparatus of claim 2, wherein the at least one processor coupled to the at least one memory is configured to:
receive, from a blockchain data provider, a current snapshot of balances at each address;
attribute a respective transaction for a respective address to an unknown group; and
when a new transaction occurs to the at least one respective member address as identified from the first table, re-attribute the new transaction to the at least one respective member address such that the new attribution state includes the at least one respective member address.

10. The apparatus of claim 9, wherein a mitigation algorithm prevents a disproportionate attribution to groups for transactions occurring shortly after the current snapshot of balances at each address.

11. The apparatus of claim 1, wherein the at least one processor coupled to the at least one memory and configured to:
deduplicate the event to sure that it has not already been processed;
record relevant changes associated with the new attribution state to an audit log;
extract the group attribution state by reading from the first table and the second table; and
cache an acknowledgement of the event as having been processed for a later deduplication stage.

12. The apparatus of claim 1, wherein when the event comprises a transfer of a portion of an attributed circulation from an address, the apparatus further configured to select a transfer methodology from a list of transfer methodologies comprising: a first approach based on historical ordering, a second approach based on proportional to attributed circulation, a third approach equally split across groups, a fourth approach based on group characteristics, a fifth approach based on destination address, a sixth approach based on a randomly selected group and a seventh approach based on discrepancies between a source address and a destination address.

13. The apparatus of claim 1, wherein the proposed change is determined based on rules that determine how much of an attributed circulation is shared by groups, wherein the rules specify at least one of a modifier, a matcher, an exclusivity and an algorithm.

14. The apparatus of claim 13, wherein the algorithm comprises one of an upstream algorithm in which a first configured modifier related to a first modified amount is shared with an upstream entity or a downstream algorithm in which a second configured modifier related to a second modified amount is shared with a downstream entity.

15. The apparatus of claim 14, wherein, when the algorithm comprises the downstream algorithm, the at least one processor coupled to the at least one memory and configured to:
associate an attributed circulation to the downstream entity as locked to prevent the attributed circulation from being moved by later events.

16. The apparatus of claim 1, wherein the second table further stores at least one of a transaction count per event and a token age per token associated with the event and wherein the at least one processor coupled to the at least one memory is configured to: utilize a time-based cache such that, when originating a tokenized asset, if an entry related to an originated attribution is stored in the time-based cache, the originated attribution is obtained from the time-based cache rather than being attributed to an originator of the new tokenized asset.

17. The apparatus of claim 1, wherein the at least one processor coupled to the at least one memory is configured to:
receive a current snapshot of balances at each address;
attribute a respective transaction for a respective address to an unknown group; and
when a new transaction occurs to the at least one respective member address as identified from the first table, re-attribute the new transaction to the at least one respective member address such that the new attribution state includes the at least one respective member address and according to one of a per-entity re-attribution cap or a limit to a percentage applied to a single transaction to avoid disproportionate credit re-attribution for transactions after the current snapshot.

18. A method for generating attribution data associated with transactions, the method comprising:
receiving an event associated with a transaction in a network;
determining, based on the event, a proposed change to a group attribution state by reading first data from a first table that stores a listing of group addresses in which each member in the listing of group addresses has at least one respective member address and second data from a second table comprising the group attribution state; and
applying the proposed change to the group attribution state to the second table to obtain an updated second table with a new attribution state.

19. The method of claim 18, wherein the network comprises a blockchain network and wherein the method operates off-chain relative to the blockchain network.

20. The method of claim 18, wherein the event comprises one or more of a data type, a source address, a destination address, an amount, a blockchain network identifier, a timestamp, a state, and a token.

21. The method of claim 20, wherein the data type comprises one or more of an originating of a token, a terminating of a token, a transfer of a token, a cross-chain transaction for a token and wherein the token comprises a tokenized asset.

22. The method of claim 21, wherein the cross-chain transfer of N tokens comprises a termination of first N tokens from a source chain and a mint or origination of second M tokens on a destination chain and wherein the proposed change to the group attribution state to the second table to obtain the updated second table with the new attribution state takes into account the termination of the first N tokens from the source chain and the mint or origination of the second M tokens on the destination chain.

23. The method of claim 19, wherein the second table comprising the group attribution state further comprises a snapshot identifier for each entry in the second table, the snapshot identifier enabling a sorting of data in the second table, a filtering of data in the second table, or a separate action associated with the data in the second table.

24. The method of claim 23, wherein the snapshot identifier comprises at least one of a date, a time, a value and an incremental value every N transfers.

25. The method of claim 19, further comprising:
performing at least one of: replaying events in the blockchain network to populate the second table and bringing the second table up to date to begin processing new events from the blockchain network.

26. The method of claim 18, further comprising:
receiving, from a blockchain data provider, a current snapshot of balances at each address;
attributing a respective transaction for a respective address to an unknown group; and
when a new transaction occurs to the at least one respective member address as identified from the first table, re-attributing the new transaction to the at least one respective member address such that the new attribution state includes the at least one respective member address.

27. The method of claim 26, wherein a mitigation algorithm prevents a disproportionate attribution to groups for transactions occurring shortly after the current snapshot of balances at each address.

28. The method of claim 18, further comprising:
deduplicating the event to sure that it has not already been processed;
recording relevant changes associated with the new attribution state to an audit log;
extracting the group attribution state by reading from the first table and the second table; and
caching an acknowledgement of the event as having been processed for a later deduplication stage.

29. The method of claim 18, wherein when the event comprises a transfer of a portion of an attributed circulation from an address, the method further comprising selecting a transfer methodology from a list of transfer methodologies comprising: a first approach based on historical ordering, a second approach based on proportional to attributed circulation, a third approach equally split across groups, a fourth approach based on group characteristics, a fifth approach based on destination address, a sixth approach based on a randomly selected group and a seventh approach based on discrepancies between a source address and a destination address.

30. The method of claim 18, wherein the proposed change is determined based on rules that determine how much of an attributed circulation is shared by groups, wherein the rules specify at least one of a modifier, a matcher, an exclusivity and an algorithm.

31. The method of claim 30, wherein the algorithm comprises one of an upstream algorithm in which a first configured modifier related to a first modified amount is shared with an upstream entity or a downstream algorithm in which a second configured modifier related to a second modified amount is shared with a downstream entity.

32. The method of claim 31, wherein, when the algorithm comprises the downstream algorithm, the method further comprising:
associating an attributed circulation to the downstream entity as locked to prevent the attributed circulation from being moved by later events.

33. The method of claim 18, wherein the second table further stores at least one of a transaction count per event and a token age per token associated with the event and wherein the method further comprises:
utilizing a time-based cache such that, when originating a tokenized asset, if an entry related to an originated attribution is stored in the time-based cache, the originated attribution is obtained from the time-based cache rather than being attributed to an originator of the new tokenized asset.

34. The method of claim 18, wherein the method further comprises:
receiving a current snapshot of balances at each address;
attributing a respective transaction for a respective address to an unknown group; and
when a new transaction occurs to a tracked address as identified from the first table, re-attributing the new transaction to the tracked address such that the new attribution state includes the tracked address and according to one of a per-entity re-attribution cap or a limit to a percentage applied to a single transaction to avoid disproportionate credit re-attribution for transactions after the current snapshot.

35. A computer-readable storage medium storing instructions, which, when executed by a processor, cause the processor to be configured to:
receive an event associated with a transaction in a network;
determine, based on the event, a proposed change to a group attribution state by reading first data from a first table that stores a listing of group addresses in which each member in the listing of group addresses has at least one respective member address and second data from a second table comprising the group attribution state; and
apply the proposed change to the group attribution state to the second table to obtain an updated second table with a new attribution state.
